(19) United States
(12) Patent Application Publication
(10) Pub. No.: US 2025/0278759 A1
(43) Pub. Date: Sep. 4, 2025

(54) SYSTEM AND METHOD FOR FILTERING DATA FOR TRANSMISSION TO USER DEVICES

(71) Applicant: Just Crossed Corporation, Tampa, FL (US)

(72) Inventor: Manny MANZEL, Summerlin, NV (US)

(21) Appl. No.: 19/199,319

(22) Filed: May 5, 2025

Related U.S. Application Data
(63) Continuation-in-part of application No. 19/064,561, filed on Feb. 26, 2025.
(60) Provisional application No. 63/558,546, filed on Feb. 27, 2024.

(51) Int. Cl. G06Q 30/0251

(52) U.S. Cl. CPC G06Q 30/0261

(57) ABSTRACT

Aspects of the present disclosure relate generally to systems and methods for filtering data transmitted by a server to a user device of a user. In an aspect, a method includes storing an advertisements database that includes advertisements for each respective business from a subscriber database that includes location information of businesses. The method further includes receiving location information and trajectory information of the user. The method also includes representing, based on the location information of a business, a physical region of interest proximate to the business by a geometric shape. The method additionally includes filtering the advertisements database, to select for display to the user, at least one advertisement corresponding to the business, responsive to the trajectory of the user being within at least a portion the geometric shape. The method further includes transmitting the at least one advertisement to the user device.

### CROSS REFERENCE TO RELATED APPLICATIONS

This application is a continuation-in-part application of U.S. patent application Ser. No. 19/064,561, filed on Feb. 26, 2025, which claims priority to U.S. Provisional Application No. 63/558,546, filed Feb. 27, 2024, the entire contents of each of which are hereby incorporated by reference.

### TECHNICAL FIELD

Aspects of the present disclosure relate generally to systems and methods for filtering and transmitting electronic information based on a location and a trajectory of a user. The electronic information can include, for example, location-based mobile advertising, pictures and biographies for social interaction or commerce, and/or ice breaking phrases for social interaction.

### BACKGROUND

People paths may include being proximate to various business. Thus, there is a need for a way to enable people who are near a particular business to receive targeted advertisements relating to the particular business and the user's interests.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to an aspect of the present disclosure, a method is provided for filtering data transmitted to a user device of a user. The method includes subscribing, by a server having one or more processors, one or more memories, a transmitter and a receiver, users from among businesses and consumers, to a proximity-based mobile advertising service, to form a subscriber database. The method further includes storing, by the one or more memories, an advertisements database that includes one or more advertisements for each respective business from the subscriber database. The method also includes receiving, by the receiver, location information and trajectory information of the user. The method additionally includes representing, by the one or more processors based on the location information and the trajectory information of the user, a physical region of interest proximate to the user by a geometric shape. The method further includes filtering, by the one or more processors, the advertisements database, to select for display to the user, at least one advertisement corresponding to a subscribing business, responsive to the subscribing business being within a trajectory of at least a portion the geometric shape. The method also includes transmitting, by the transmitter to the user device, the at least one advertisement.

According to another aspect of the present disclosure, a system is provided for filtering data transmitted to a user device of a user. The system includes a receiver configured to receive location information and trajectory information of the user. The system further includes one or more memories, individually or in combination, having instructions and an advertisements database that includes one or more advertisements for each respective business from a subscriber database. The system also includes one or more processors each coupled to at least one of the one or more memories and configurable/operable to execute the instructions to: subscribe users from among businesses and consumers to a proximity-based mobile advertising service to form a subscriber database; represent, based on the location information and the trajectory information of the user, a physical region of interest proximate to the user by a geometric shape; and filter the advertisements database, to select for display to the user, at least one advertisement corresponding to a subscribing business, responsive to the subscribing business being within a trajectory of at least a portion the geometric shape. The system additionally includes a transmitter configured to transmit the at least one advertisement to the user device.

According to yet another aspect of the present disclosure, a method is provided for filtering data transmitted to a user device of a user. The method includes subscribing, by a server having one or more processors, one or more memories, a transmitter and a receiver, users from among businesses and consumers, to a proximity-based event and content access service to form a subscriber database of subscriber information. The method further includes storing, by the one or more memories, exclusive digital content provided by the businesses in an exclusive digital content database. The method also includes receiving, by the receiver, location information and trajectory information of the user. The method additionally includes representing, by the one or more processors based on the location information and the trajectory information of the user, a physical region of interest proximate to the user by a geometric shape. The method further includes filtering, by the one or more processors, the exclusive digital content database to identify one or more items of exclusive digital content provided by one or more of the businesses that are within a trajectory of at least a portion of the geometric shape. The method also includes transmitting, by the transmitter to the user device, the one or more items of exclusive digital content.

According to a further aspect of the present disclosure, a system is provided for filtering data transmitted to a user device of a user. The system includes a receiver configured to receive location information and trajectory information of the user. The system further includes one or more memories, individually or in combination, having instructions and an exclusive digital content database including exclusive digital content provided by businesses. The system also includes one or more processors each coupled to at least one of the one or more memories and configurable/operable to execute the instructions to: subscribe users from among the businesses and consumers, to a proximity based event and content access service to form a subscriber database of subscriber information; store exclusive digital content provided by the businesses in an exclusive digital content database; represent, based on the location information and the trajectory information of the user, a physical region of interest proximate to the user by a geometric shape; and filter the exclusive digital content database to identify one or more items of exclusive digital content provided by one or more of the businesses that are within a trajectory of at least a portion of the geometric shape. The system additionally includes a transmitter configured to transmit the one or more items of exclusive digital content.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates an example of a computer environment, in accordance with example aspects of this disclosure.

FIG. 2 illustrates an example environment to which aspects of the present disclosure can be applied, in accordance with an example aspects of this disclosure.

FIG. 3 illustrates an example method for location-based mobile advertising, in accordance with example aspects of this disclosure.

FIGS. 4-6 illustrates further steps of the method of FIG. 3, in accordance with example aspects of this disclosure.

FIGS. 7-8 illustrates further steps of the method of FIG. 3 directed to different monetization models, in accordance with example aspects of this disclosure.

FIG. 9 illustrates an initial screen for a user subscription sign up, in accordance with example aspects of the present disclosure.

FIG. 10 illustrates a user and a user display with a map application using a path-based advertisement approach, in accordance with example aspects of the present disclosure.

FIG. 11 illustrates a user and a geofence, in accordance with example aspects of the present disclosure.

FIG. 12 illustrates a targeted advertisement from a subset of targeted advertisements, in accordance with example aspects of the present disclosure.

FIG. 13 illustrates a method for adjusting the geofence or proximity radius, in accordance with example aspects of the present disclosure.

FIG. 14 illustrates a geofence and extended geofences, the latter two for proximity-based mobile advertising using time-limited proximity boosts, in accordance with example aspects of the present disclosure.

FIG. 15 illustrates a method for adjusting the geofence or proximity radius using time-limited proximity boosts, in accordance with example aspects of the present disclosure.

FIGS. 16-21 illustrate further blocks of the method of FIG. 15, in accordance with example aspects of the present disclosure.

FIG. 22 illustrates a method for proximity-based event and content access, in accordance with example aspects of the present disclosure.

FIG. 23 illustrates a method for adjusting the geofence or proximity radius using heat-map based time-limited proximity boosts, in accordance with example aspects of the present disclosure.

FIG. 24 illustrate further blocks of the method of FIG. 23, in accordance with example aspects of the present disclosure.

### DETAILED DESCRIPTION

Exemplary aspects of the present disclosure relate generally to systems and methods for generating and transmitting electronic information based on location and trajectory of a user, such as location-based mobile advertising.

In a world where personalized experiences are paramount, the proposed location-based mobile advertising service revolutionizes the way businesses connect with their target audience.

Leveraging the power of geolocation technology, the service will seamlessly integrate with in-application clients on mobile devices, presenting users with tailored offer feed based on their physical proximity to established advertising partners, all within an adjustable radius.

Exemplary aspects of the present disclosure may be performed in an actual physical environment and/or a virtual reality environment. The environments may overlap such that something that happens in one environments affects and/or otherwise also occurs in the second environment (e.g., likes, purchases, reviews, etc.).

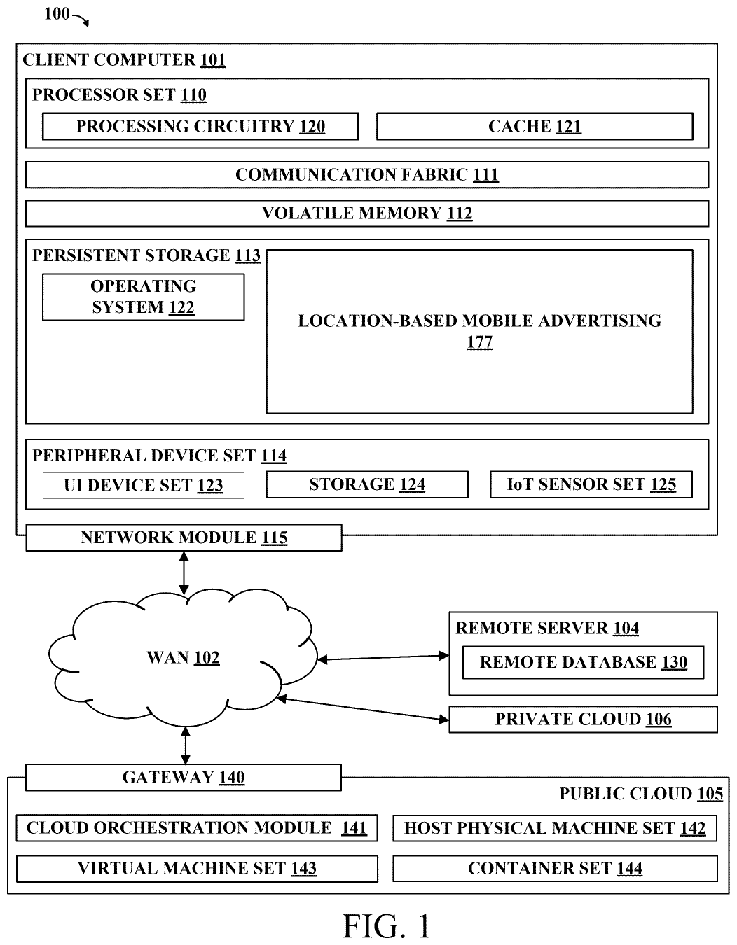

Referring to FIG. 1, an example computing environment 100 is shown, in accordance with example aspects of this disclosure.

Computing environment 100 includes an example of an environment for the execution of at least some of the computer code 177 involved in performing the inventive methods, such as location-based mobile advertising. In addition to computer code 177, computing environment 100 includes, for example, computer 101, wide area network (WAN) 102, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computer code 177, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically, computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in computer code 177 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or opensource Portable Operating System Interface type operating systems that employ a kernel. The code included in computer code 177 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, virtual reality goggles, augmented reality goggles, mixed reality goggles, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) configured to communicate computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Public cloud may provide a subscription service for people interaction to a plurality of users such as a user of computer 101. The service can have multiple purposes for people interaction. Such purposes for people interaction can include dating, friendship, and business.

In an aspect, public cloud 105 operates in conjunction with remote server 104 to enable profile information of users to be retrieved and provided to a user such as one using computer 101 and/or another user operating a similar device as computer 101.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

While remote server 104 is shown as a separate entity from private cloud 106 and public cloud 105, in other aspects, the server 104 may be located in private cloud 106 and/or public cloud 105. In an aspect, user profile information is stored in private cloud 106 and advertisements are stored in public cloud 105. In this way, the advertisements can be accessed irrespective of proximity to user location such as, for example, through a search engine over the Internet, while private information relating to a user's profile is securely stored in private cloud 106. However, it is envisioned that aspects of this disclosure will be used by the user is in motion in a location near businesses, such as on a single street with one or more businesses, a shopping mall with tens of businesses, and so forth.

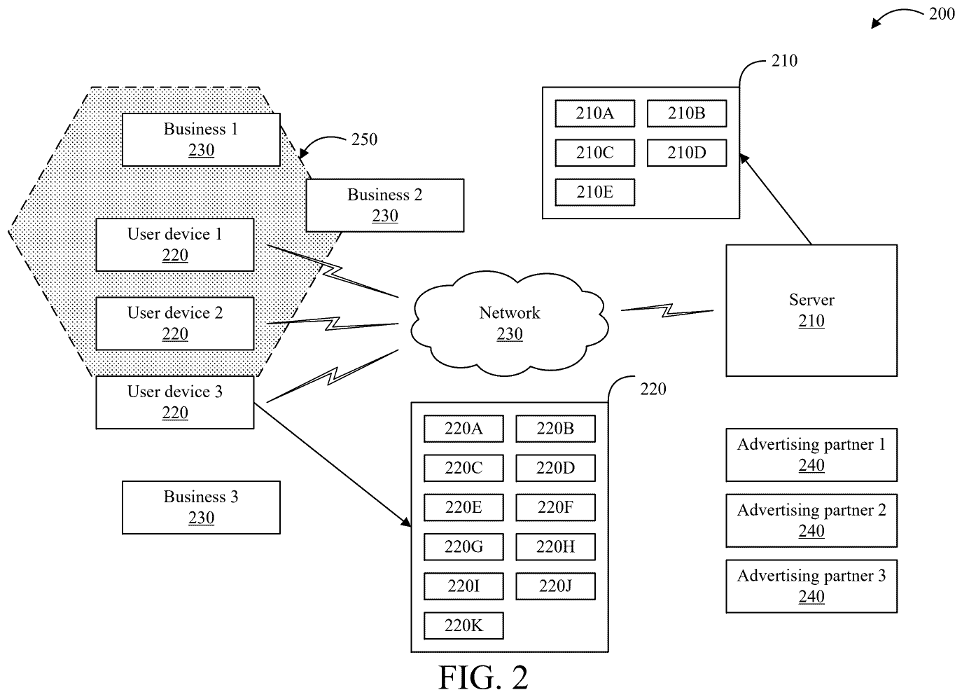

Referring to FIG. 2, an example environment 200 to which aspects of the present disclosure can be applied is shown, in accordance with example aspects of this disclosure. As shown, the environment 200 includes a server 210, a set of user devices (user device 1 through 3) 220, a set of businesses (businesses 1-3) 230, and a set of advertising partners (advertising partners 1-3) 240. According to an exemplary aspect, the server 210 can be configured to store information (e.g., user profiles) for location-based mobile advertising and other types of electronic information and can provide such information to the server 210 for use in disseminating targeted advertisements to users that are proximate to the business to which the advertisements correspond. It should be appreciated that the server 210 can correspond to one or more of remote server 104, public cloud 105 and/or private cloud 106 according to exemplary aspects. Moreover, the set of user devices 220 may include any type of a smart phone, a tablet, a laptop computer, a mobile computer, a desktop computer, a multimedia player, and so forth. In an aspect, server 210 corresponds to remote server 104 and/or public cloud 105 of FIG. 1, and user devices 220 each correspond to an implementation of computer 101 of FIG. 1.

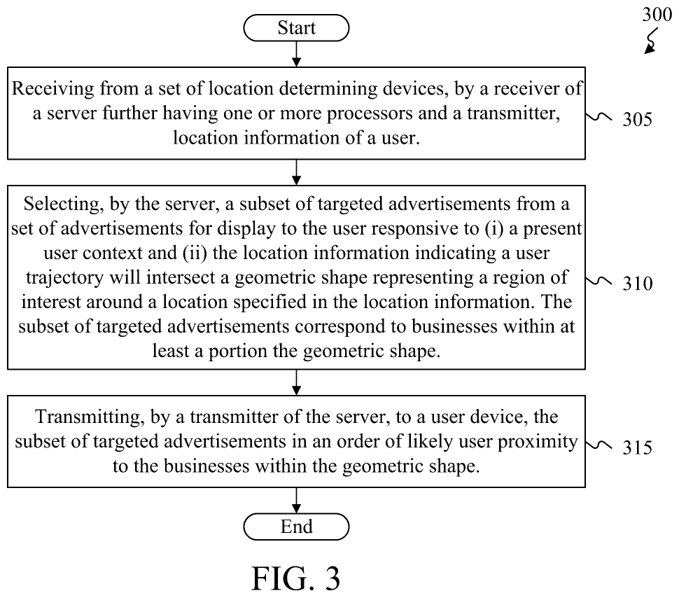

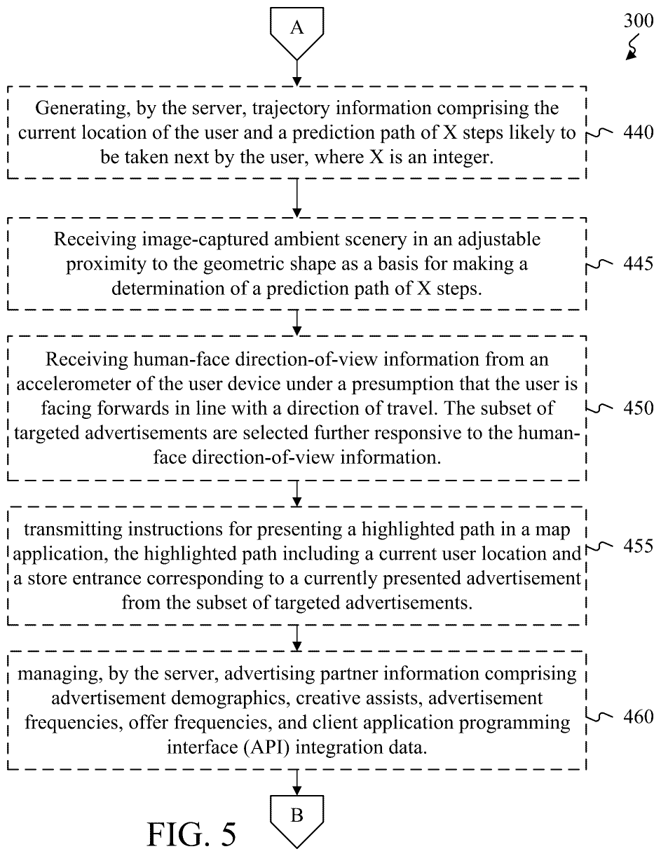

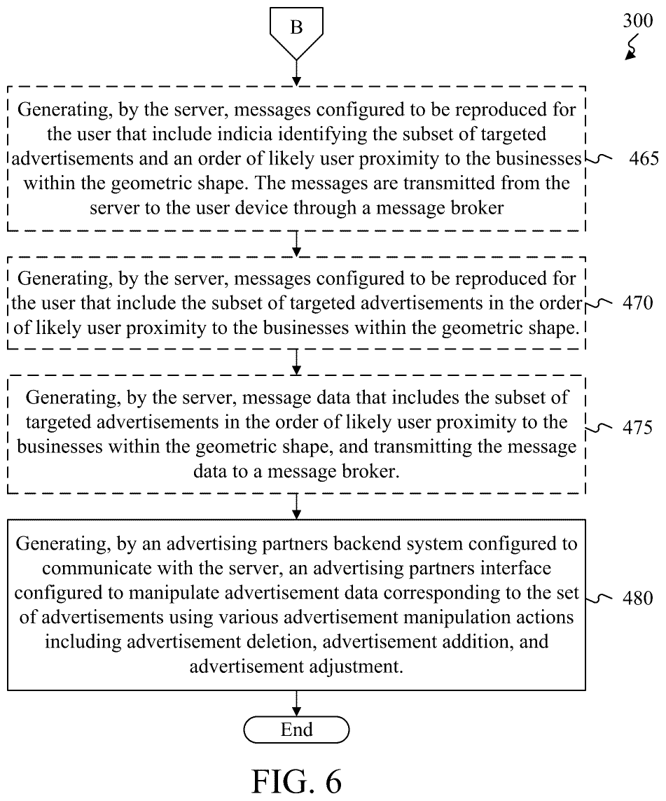

Each device in the set of user devices 220 at least includes, for example, at least one processor 220A for executing computer code and at least one memory 220B (which can correspond to processor set 110 of FIG. 1 in an exemplary aspect) for storing program code, a Global Positioning System (GPS) 220C for determining a position of a user device 220, a communication system 220D for enabling bi-directional communications between the user device 220 and other entities such as the server 210, a display 220E for displaying information such as advertisements, people of interest, user profile data, and so forth, an input device 220F for receiving user inputs, an assisted GPS 220G for using GPS and other information to determine a position of a user device 220, a WI-FI positioning system 220H for determining a position of a user device 220, e.g., using triangulation, an accelerometer 2201 for providing motion data for a user device 220, a camera 220J for providing image data of images proximate to a user device 220, and a speaker 220K for reproducing acoustic data, operatively coupled to the at least one processor 220A. Each memory 220B includes program code for a method for a location-based mobile advertising service. The method may include steps from method 300 of FIG. 3-7. The at least one processor 220A may be a single or multicore processor(s), and may include a central processing unit(s) and/or a graphics processing unit(s).

The GPS system 220C typically has a location services setting that allows for authorized applications to track the location and trajectory (including direction and speed) of the user. In an aspect, a geofence 250, which can be considered a “proximity radius”, is implemented with respect to a user's location such that only businesses 230 within the geofence 250 can be considered for recommendation to the user device 220 depending on a user's profile as described more fully hereinbelow. In an aspect, only a physical portion of a business (e.g., the door(s)) is needed to be in the geofence 250 for that business to be considered when deciding which businesses to target for the user 1001 via advertising tailored for, or at the least, selected from other advertisements based on user proximity and user profile information. As used herein, the term “geofence” corresponds to a location defined boundary (e.g., a proximity radius) that may take the form of a straight line is some aspects or simple (e.g., triangle, circle, square, rectangular) or complex (e.g., typically having 5 or more sides such as, e.g., a hexagon, a decagon, etc.) shapes in other aspects. In another aspect, trapezoids may also be considered as complex shapes in lacking two pairs of parallel sides (instead having only one). In this way, businesses may be “caught” within the geofence as the user traverses, thus resulting in the user receiving targeted advertisements for those businesses.

The distance implemented by the geofence 250 is preferably one that coincides with a typical range that a person scans carefully when walking/traveling. The geofence 250 can be predefined and/or dynamically adjusted as described below. For example, while a person is walking in a direction, they may or may not notice businesses 230 within a given radius (e.g., a proximity radius), but are more likely to notice businesses 230 that are on a trajectory that may possibly invade their personal space or that may overlap with or get close to their personal space. Thus, a short distance for a proximity radius of 150 meters may be used in some embodiments. It should be appreciated that the proximity radius of 150 meters is predefined distance, which is exemplary, and which can be dynamically adjusted as described herein. In some aspects, the proximity radius used by the present disclosure may be user adjustable. In some aspects, the proximity radius may be adjusted based on the various criteria including store density (e.g., shrinking the proximity radius when there are many stores within a predefined area versus increasing the proximity radius when there are few stores within a predefined area, closing times (stores about to close have their advertisements issued before stores that will remain open for a while longer) and user profile information (e.g., gender, age, interests, available funds for spending in one or more accounts or available on one or more types of cards such as credit and/or debit cards), and so forth.

In the aspect of FIG. 2, the server 210 at least includes, for example, at least one processor 210A and at least one memory 210B, a communication system 210C (including, e.g., a transmitter and a receiver or a transceiver), a display 210D, and an input device 210E, operatively coupled to the at least one processor 210A. Each memory 210B includes code for a method for a location-based mobile advertising service, including generating and/or dynamically adjusting the geofence 250 (e.g., the proximity radius) based on the user's location and trajectory information as described herein. The method may include steps from method 300 of FIG. 3-7. The at least one processor 210A may be a single or multicore processor(s), and may include a central processing unit(s) and/or a graphics processing unit(s).

The set of user devices 220 communicate with each other and the remote server 210 with one or more networks (collectively denoted “network”) 230.

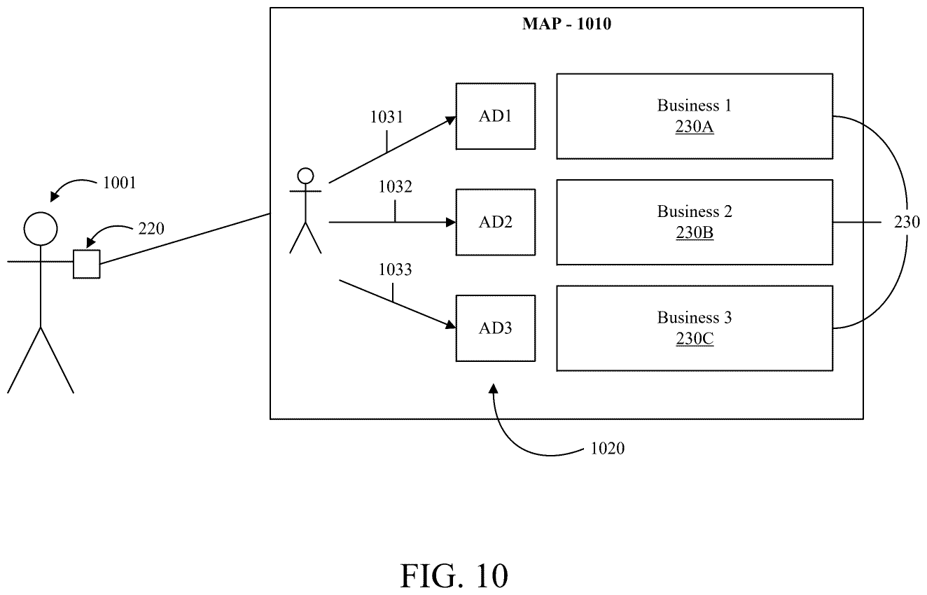

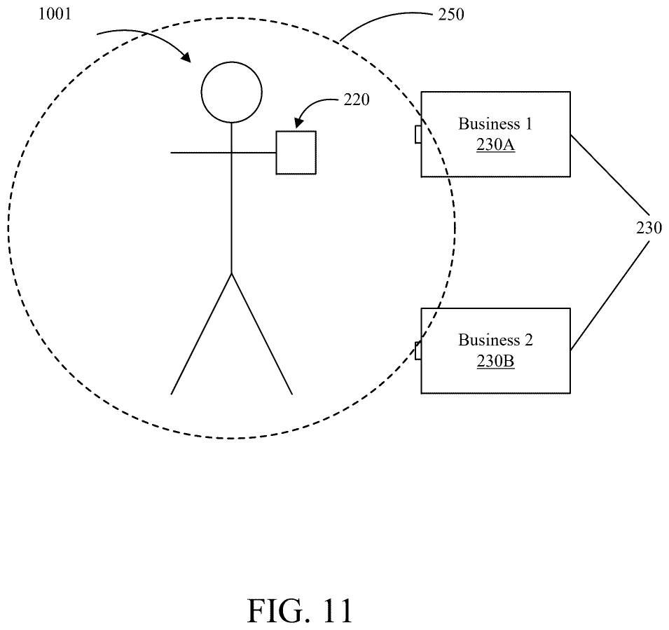

Referring to FIG. 3, an example method 300 for location-based mobile advertising is shown, in accordance with example aspects of this disclosure. See FIG. 10 for an example of how the targeted advertisements may be displayed to a user, in accordance with example aspects of this disclosure. See FIG. 11 for an example of a geofence implemented by a geometric shape, in accordance with example aspects of this disclosure.

At block 305, the method 300 includes receiving from a set of location determining devices (e.g., GPS 220C, assisted GPS 220G, WI-FI positioning system 220H, accelerometer 2201), by a receiver 210C of a server 210 further having one or more processors 210A and a transmitter 210C, location information of a user 1001. This information can used to calculate the user's current location, trajectory, and pace or speed of movement using convention location determining and GPS tracking techniques as would be understood to those skilled in the art. For example, tracking the user's current physical location over a predefined amount of time will enable the system to calculate both the heading direction and pace or speed of travel for the user, which can be considered the user's trajectory.

At block 310, the method 300 includes selecting, by the server 210, a subset of targeted advertisements 1020 from a set of advertisements for display to the user 1001 responsive to (i) a present user context and (ii) the location information indicating a user trajectory will intersect a geometric shape 250 representing a region of interest around a location specified in the location information. The subset of targeted advertisements 1020 correspond to businesses 230 within at least a portion the geometric shape 250.

At block 315, the method 300 includes transmitting, by a transmitter 210C of the server 210, to a user device 220, the subset of targeted advertisements 1020 in an order of likely user proximity to the businesses 230 within the geometric shape 250.

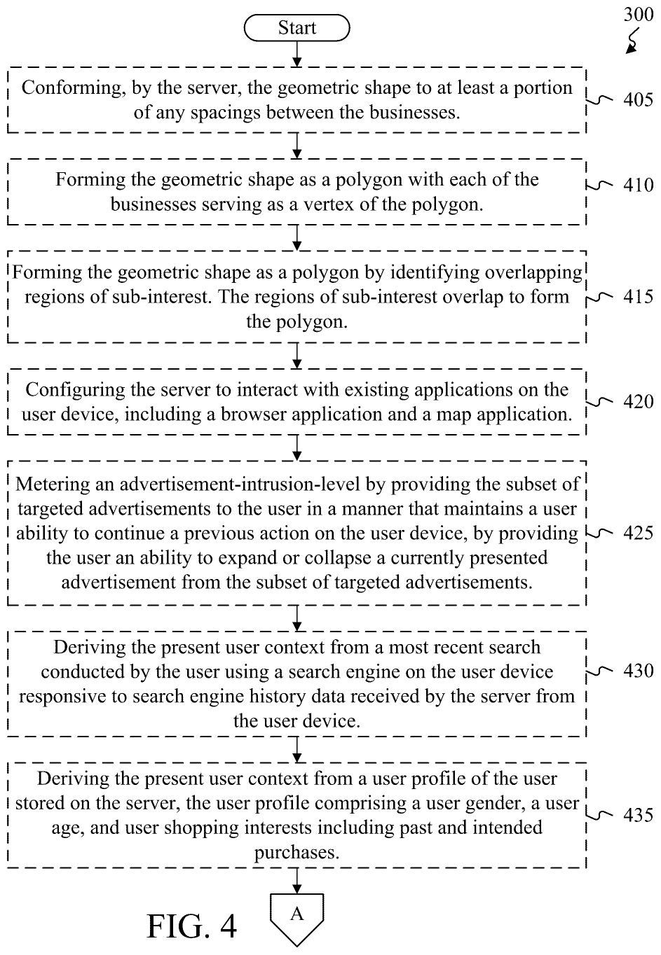

Referring to FIGS. 4-6, further steps of the method 300 of FIG. 3 are shown, in accordance with example aspects of this disclosure. It is noted that the steps of the methods shown therein can be performed in sequence or in parallel and that one or some steps may be omitted in certain instances.

At block 405, the method 300 includes conforming, by the server 210, the geometric shape 250 to at least a portion of any spacings between the businesses 230.

At block 410, the method 300 includes forming the geometric shape 250 as a polygon with each of the businesses 230 serving as a vertex of the polygon.

At block 415, the method 300 includes forming the geometric shape 250 as a polygon by identifying overlapping regions of sub-interest. The regions of sub-interest overlap to form the polygon. It should be appreciated that the polygon is an exemplary shape and other shapes can be used, such as circles, squares or the like.

At block 420, the method 300 includes configuring the server 210 to interact with existing applications stored in the one or more memories 210B on the user device 220, including a browser application and a map application.

At block 425, the method 300 includes metering an advertisement-intrusion-level by providing the subset of targeted advertisements 1020 to the user 1001 in a manner that maintains a user ability to continue a previous action on the user device 220, by providing the user an ability to expand or collapse a currently presented advertisement from the subset of targeted advertisements 1020.

At block 430, the method 300 includes deriving the present user context from a most recent search conducted by the user using a search engine on the user device 220 responsive to search engine history data received by the server 210 from the user device 220.

At block 435, the method 300 includes deriving the present user context from a user profile of the user stored on the server 210. The user profile includes a user gender, a user age, and user shopping interests including past and intended purchases. For example, the private cloud 106 can be configured to store user profile data that is either automatically collected (such as through history of the search engine) and/or entered by the user. More specifically, the user can be presented a user interface that enables the user to enter certain preferences and life style choices that would enable the system and method to provide a more customized experience for the user, which again is tied to the geolocation and trajectory as will be described herein in detail.

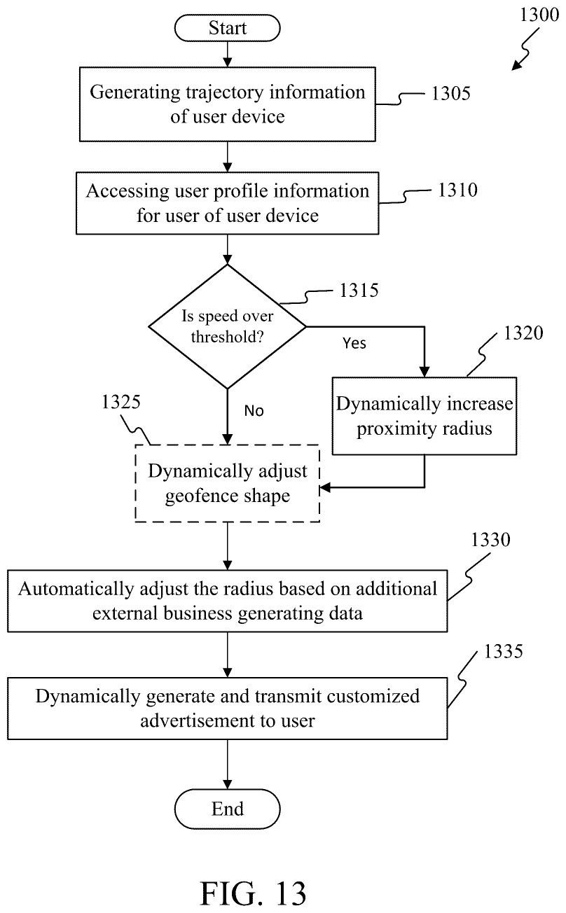

At block 440, the method 300 includes generating, by the server 210, trajectory information comprising the current location of the user and a prediction path of X steps likely to be taken next by the user, where X is an integer. As described below with respect to FIG. 13, the trajectory can be determined based on whether the user is walking or driving or some other type of transportation such as bicycling, for example.

At block 445, the method 300 incudes receiving image-captured ambient scenery in an adjustable proximity to the geometric shape as a basis for making a determination of a prediction path of X steps. In an aspect, the ambient scenery may include, e.g., existing pathways and doorways versus open fields and walls.

At block 450, the method 300 includes receiving human-face direction-of-view information from an accelerometer 2201 of the user device 220 under a presumption that the user is facing forwards in line with a direction of travel. The subset of targeted advertisements are selected further responsive to the human-face direction-of-view information.

At block 455, the method 300 includes transmitting instructions for presenting a highlighted path in a map application, the highlighted path including a current user location and a store entrance corresponding to a currently presented advertisement from the subset of targeted advertisements. The instructions will be received by the user's device and configure an application, such as an application for displaying maps and directions, to illustrate the designated path.

At block 460, the method 300 includes managing, by the server, advertising partner information comprising advertisement demographics, creative assists, advertisement frequencies, offer frequencies, and client application programming interface (API) integration data.

At block 465, the method 300 includes generating, by the server, messages configured to be reproduced for the user that include indicia identifying the subset of targeted advertisements and an order of likely user proximity to the businesses within the geometric shape. The messages are transmitted from the server to the user device through a message broker. Block 465 is directed to a scenario where a message broker pre-stores advertisements for dissemination to users 1001. In an aspect, message broker is another server similar to server 210. In an aspect, message broker is a server implemented in private cloud 106 and/or public cloud 105.

At block 470, the method 300 includes generating, by the server 210, messages configured to be reproduced for the user that include the subset of targeted advertisements in the order of likely user proximity to the businesses within the geometric shape. Block 470 is directed to a scenario where messages are sent directly from the server 210 to user devices 220. In this aspect, the server 210 may be configured to calculate the user's trajectory, as described above, and then based on stored business data (which may include each businesses address) determine the order of businesses the user may encounter in the current determined trajectory and that are within the dynamically generated proximity basis. Moreover, it should be appreciated that the selected businesses will be filtered based on the present user context and user profile data as described herein.

At block 475, the method 300 includes generating, by the server 210, message data that includes the subset of targeted advertisements in the order of likely user proximity to the businesses within the geometric shape, and transmitting the message data to a message broker. Block 475 is directed to a scenario where messages are sent to a message broker that disseminates the messages to users 1001. The selected messages can be then transmitted and displayed on the user's device accordingly. It should be appreciated that they messages can be displayed within a mapping interface that displays the proximity radius and may, for example, display the travel time for the user to each business.

At block 480, the method 300 includes generating, by an advertising partners backend system configured to communicate with the server, an advertising partners interface configured to manipulate advertisement data corresponding to the set of advertisements using various advertisement manipulation actions including advertisement deletion, advertisement addition, and advertisement adjustment.

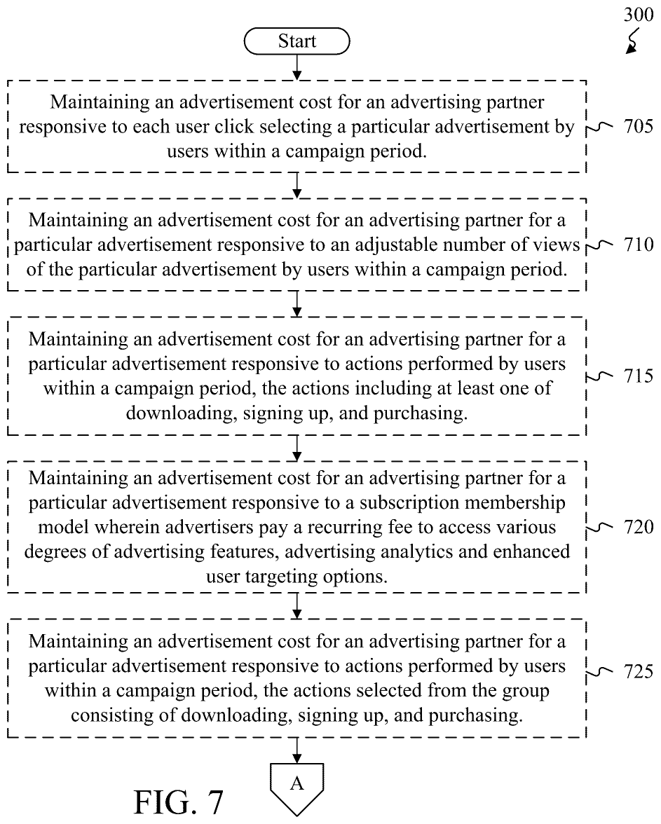

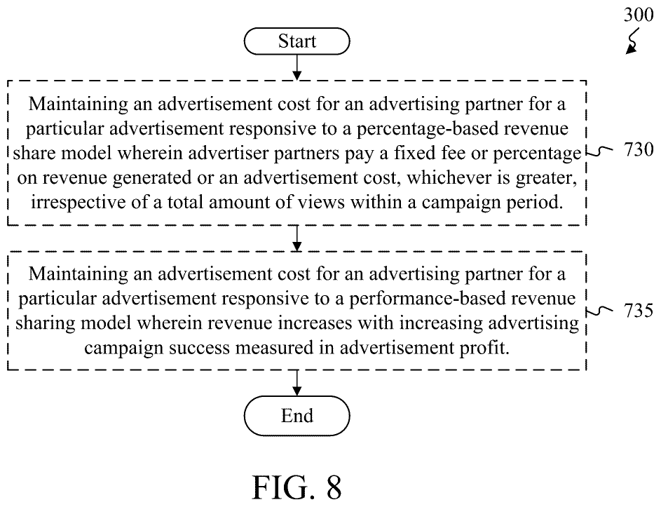

Referring to FIGS. 7-8, further steps of the method 300 of FIG. 3 directed to different monetization models are shown, in accordance with example aspects of this disclosure.

At block 705, the method 300 includes maintaining an advertisement cost for an advertising partner 240 responsive to each user click selecting a particular advertisement by users within a campaign period.

At block 710, the method 300 includes maintaining an advertisement cost for an advertising partner 240 for a particular advertisement responsive to an adjustable number of views of the particular advertisement by users within a campaign period.

At block 715, the method 300 includes maintaining an advertisement cost for an advertising partner 240 for a particular advertisement responsive to actions performed by users within a campaign period, the actions including one or more of downloading, signing up, purchasing, and so forth.

At block 720, the method 300 includes maintaining an advertisement cost for an advertising partner 240 for a particular advertisement responsive to a subscription membership model wherein advertisers pay a recurring fee to access various degrees of advertising features, advertising analytics and enhanced user targeting options.

At block 725, the method 300 includes maintaining an advertisement cost for an advertising partner 240 for a particular advertisement responsive to a percentage-based revenue share model wherein an advertising platform takes a percentage of revenue generated though the subset of target advertisements.

At block 730, the method 300 includes maintaining an advertisement cost for an advertising partner 240 for a particular advertisement responsive to a percentage-based revenue share model wherein advertiser partners 240 pay a fixed fee or percentage of revenue generated or an advertisement cost, whichever is greater, irrespective of a total amount of views within a campaign period.

At block 735, the method 300 includes maintaining an advertisement cost for an advertising partner 240 for a particular advertisement responsive to a performance-based revenue sharing model wherein revenue increases with increasing advertising campaign success measured in advertisement profit.

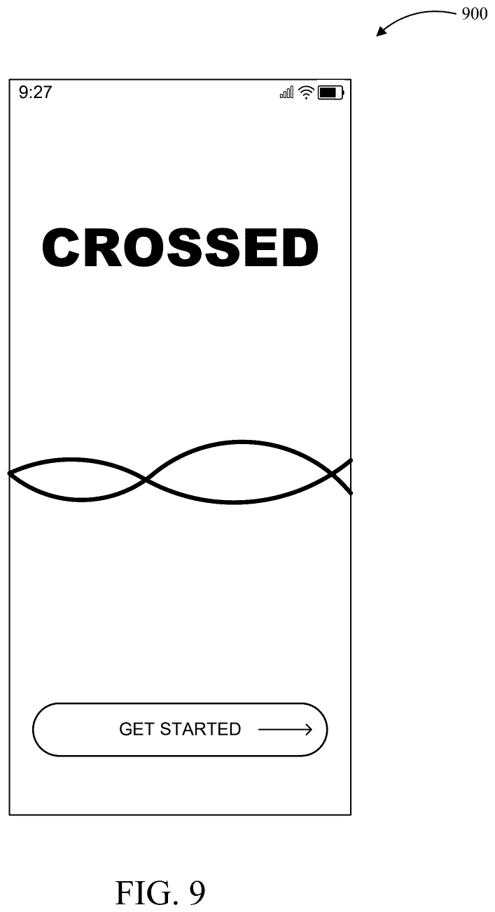

Referring to FIG. 9, an initial screen 900 for a user subscription sign up is shown, in accordance with example aspects of the present disclosure.

The initial screen 900 is followed by screens (now shown) prompting the user for their personal data including, for example, but not limited to, a telephone number, an email address, a name, an age or date of birth, a place of residence, an occupation, a preferred gender preference, and interests.

In an aspect, two-factor authentication is used once the telephone number and email address are provided to ensure the identity of the user, preferably before the application continues processing user input data.

In an aspect, the user is asked to turn on location services on their device so that their location can be tracked by the location-based mobile advertising service.

Referring to FIG. 10, a user 1001 and a user display with an open map application 1010 that uses a geofence 250 are shown, in accordance with example aspects of the present disclosure.

The user 1001 is holding their mobile device 220, with a map application 1010 opened and running.

In an aspect, the map application 1010 shows the user 1001 on the map with respect to various highlighted paths 1031, 1032, and 1033 that lead to various businesses 230A, 230B, and 230C, respectively, that are within a shape implementing a geofence 250 that corresponds to an area of interest surrounding the user 1001. Moreover, in any aspect, a subset of targeted advertisements for the businesses 230 that are within the geofence 250 are provided to the user 1001. In this way, the user 1001 may be directed to specific businesses based on targeted advertisements to the user 1001 that are provided to the user due to the user's proximity to the specific businesses and the user's profile indicating an interest in something relating to the specific businesses such as items for sale, past likes, past positive reviews, and so forth.

In the example of FIG. 10, entrances of businesses 230A, 230B, and 230C intersect trajectories of predicted paths 1031, 1032, and 1033, respectively. Thus, the user 1001 is shown advertisements AD1, AD2, and AD3 corresponding to businesses 230A, 230B, and 230C, respectively. Thus, AD1, AD2, and AD3 make up the subset of targeted advertisements that are selected from a larger group presumably corresponding to advertisements for businesses not proximate to a current user location (although they may be in the future).

Regarding path prediction, in an aspect, a user's trajectory may be predicted from a map of the surroundings including existing pathways and so forth, the user's past history (e.g., visiting a store, buying from a store, viewing items in a store but not purchasing, liking, reviewing, and so forth) when traversing the same area in the past, repeated passings by particular businesses, and user interests as specified in the user profile. Thus, for example, a man walking along a path in a mall is not likely to be shown advertisements for women's clothes and vice versa, in order to specifically target the advertisements based on user characteristics and interests specified in the user profile. Of course, the preceding may differ based the user's profile, but in any event aspects of the present disclosure specifically provide targeted advertisements to a user based on a user's profile and a user's proximity to businesses having corresponding targeted advertisements available to show the user.

In an aspect, in addition to the use of the Global Positioning System (GPS) 220C, the assisted GPS 220G, and the WI-FI positioning system 220H, on-board cameras 220J of the user device 220 may match surroundings to predetermined maps stored on the server 210 in order to know where the user is relative to businesses and what advertisements to potentially show the user, with further culling of the advertisements based on the user profile. In other words, the on-board cameras 220J may be able to capture external surroundings and determine businesses and the like that are in a proximate location to the user. In any event, using this data, from a larger set of advertisements, a first subset of advertisements may be determined based on user proximity and possibly also user trajectory, and a second subset of advertisements from the first subset of advertisements may be determined based on user's profile. In this way, multiple layers of culling of a large set of advertisements may be efficiently performed to arrive at an appropriate subset of target advertisements to send to the user 1001.

In an aspect, a user 1001 is located on the map and their representation on the map will cause beeping or other sounds from a speaker 220K of the user device 220 to become louder as they approach a business for which they have asked for directions, or in another aspect, their representation on the map may become brighter or change in some user visually perceptible way (e.g., flash, etc.). In this way, a user can be directed to a business of interest from clicking on links in the advertisements for directions and other features such as dynamically created paths on the map from a current user location to a corresponding business entrance corresponding to an advertisement the user has expressed further interest in via a slider or other mechanism related to path generation on the map 1010.

Referring to FIG. 11, a user and a geofence are shown, in accordance with example aspects of the present disclosure.

In FIG. 11, entrances of businesses 230A and 230B intersect geofence 250, implemented here as the geometric shape of a circle, noting that other geometric shapes can be used. Such shapes can be tailored to the layout of the business such as to place vertexes of polygons at entrances of the business to demark them more easily versus a circle for example. To further elaborate, not every vertex position need correspond to a business or business entrance, but using vertexes easily demarks businesses than simply points on a circle. Of course, other shapes including a circle as shown may be used.

Thus, in the preceding example of FIG. 11, businesses 230A and 230B will have their advertisements shown to the user since those business are within the geofence or location boundary (ies) surrounding the user. The range of targeting a user with respect to the location of a business may be adjusted by a system administrator or tailored by each user to their own tastes and moods (e.g., in or not in a shopping mood). As will be discussed in more detail below with respect to FIG. 13, the system may be configured to dynamically and/or automatically adjust the radius (e.g., a best radius) to optimize system efficient based on different features, such as real-time foot traffic, user engagement, and outside factors, such as weather and commercial events.

In any event, it is noted that a map application is not needed in an exemplary aspect, and the user 1001 is simply presented the subset of advertisements on the user's device. In any aspect, the advertisements are provided in a manner that does not fully intrude with the screen space such as a small icon indicating a relevant advertisement(s) can be viewed should the user want to view the advertisement such that clicking on the icon makes the full advertisement appear.

In an aspect, as the user 1001 gets closer to the relevant business 230 to the advertisement they are currently viewing, their phone may produce a louder sound or stronger vibration to indicate increased proximity to the relevant business 230.

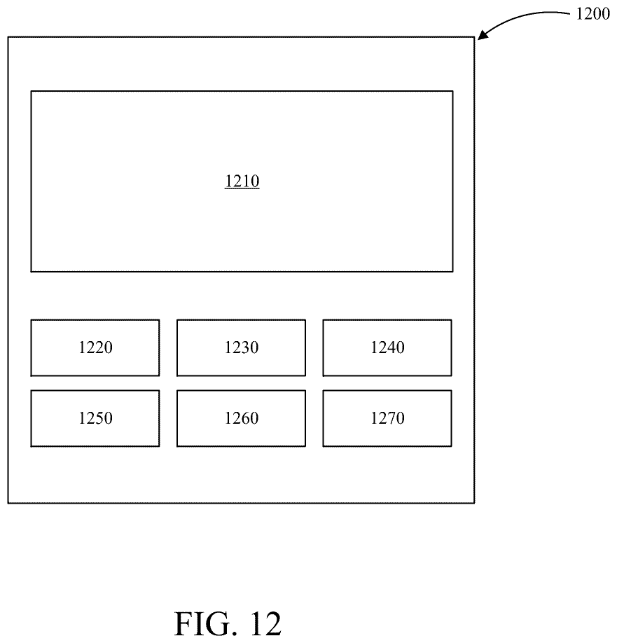

Referring to FIG. 12, a targeted advertisement 1200 from a subset of targeted advertisements is shown, in accordance with example aspects of the present disclosure.

The targeted advertisement 1200 includes ad content 1210, a distance to a business 230 corresponding to the targeted advertisement 1200, a slider 1220 to initiate the generation of a path to the business 230 corresponding to the targeted advertisement 1200, a slider 1230 to initiate sound directions to the business corresponding to the targeted advertisement 1200, a slider 1240 to request other current advertisements from the same business. These additional advertisements can be selected by a sider 1250 to be able to be based simply on proximity while removing the user profile component, and so forth. In this way, a user 1001 in a particular business 230 looking for items of interest to them may be shown other items that may be of interest to them for the purpose of gifting other people. Hence, some aspects of the present disclosure may have a timing aspect to them such that more diverse items (e.g., items not necessarily of interest based on user profile) are shown to the user at holidays such as around Christmas to broaden the targeted advertisement scope.

In an aspect, the selection of the subset of targeted advertisements that are provided to the user is made using artificial intelligence. For example, one or more specially programmed neural networks may be used to predict a subset of advertisements the user would be interested in based on the user's profile, user's past history (purchasing history, browsing history, advertisement history and corresponding success), and the user's proximity to businesses to which the subset of advertisements correspond. The one or more neural networks take in a user profile, user's past history, and a user's location relative to a business, to reduce an error in showing the user an advertisement that will lead to a purchase. No purchase results in increasing the error of a shown advertisement, while a purchase will decrease the error of a shown advertisement. In this way, the model formed from one or more neural networks may be trained. Again, reinforcement or other types of artificial intelligence and neural networks such as convolutional neural networks employing weights may be used for the advertisement subset selection to show a user at a given moment in time. Weights in a convolutional neural network can be adjusted/set based on prior purchase history, advertisement success with other users, and so forth. The system will dynamically adjust the advertisement selection shown to the user 1001 based on dynamic changes in a user's location, noting that less dynamic changes may also be implemented according to schedule such that the user's profile is reviewed every day, hour, and so forth, for changes that may affect advertisement selection. In the event of equal distance to businesses, ties may be broken based on user profile data and/or prior purchase history at the business. These and other ways may be used to break distance ties as far as ad order of advertisements being provided to the user 1001.

In an aspect, an interest meter 1260 may be shown that indicates a predicted user interest in the subject matter (ad content 1210) of an advertisement. The interest meter 1260 may be driven by an artificial intelligence network 1270 that uses one or more neural networks to predict user interests based on their prior purchases, where the artificial intelligence network learns user habits and thus appropriate predictions based on positive and/or negative reinforcement based on prior buying history with respect to targeted location-based mobile advertising. For example, advertisements resulting in all purchases will be repeated compared to advertisements for items that never result in a purchase. Moreover, advertisements resulting in all purchases will result in a higher interest level than an almost zero interest level for advertisements never resulting in purchases. Other approaches to configuring one or more neural networks to accomplish the features of the present disclosure may be used in place of reinforcement learning. However, it is envisioned that an aspect of the present disclosure implementing path prediction uses neural networks, takes a current business and advertisement and compares it to prior advertisement for that business and, in an aspect, other similar advertisements of similar or the same business, to make a prediction and reduce an ongoing prediction error until convergence, or a number of iterations have been reached, or a threshold level of error has been reached, and so forth.

FIG. 13 illustrates a method 1300 that is provided for adjusting the geofence or proximity radius according to an exemplary aspect. As described above, the distance implemented by the geofence 250 generally is configured to coincide with a typical range (e.g., a predetermined range) and in a direction (i.e., a trajectory) that may possibly cross their personal space or that may overlap with or get close to their personal space. Moreover, the proximity radius may be user adjustable, for example, by using the application on user device 220 to set a desired distance.

However, in an alternative aspect, the proximity radius may be automatically and/or dynamically adjusted to optimize the business's reach to a target customer. In this aspect, the system initially determines a trajectory of a user (e.g., the user's mobile device) at block 1305, which as described above can be determined by generating, by the server 210, trajectory information comprising the current location of the user and a prediction path of X steps likely to be taken next by the user, where X is an integer. It should be appreciated that the trajectory can include both direction and speed, which will both factor in to determining the size and shape of the proximity radius.

Next, at block 1310, the system accesses user profile information, which can include gender, age, interests (which may be customized by the user), available funds for spending in one or more accounts or available on one or more types of cards such as credit and/or debit cards and the like. As described above, the user profile information can be stored in private cloud 106 and can be customized by the user. For the example, a database can be provided in which the user can define preferences (e.g., types of cuisine, hobbies, music preferences) and the like.

As noted above, the initial proximity radius may be a predefined distance (e.g., 150 meters). At block 1315, the system may be configured to dynamically adjust the proximity radius based on the trajectory, including both speed and direction, of the user. For example, if the user's average speed is over a predefined speed threshold (e.g., 15 MPH) over a predefined time period (e.g., five minutes), the method can determine that the user is traveling in a car and therefore can be configured to dynamically adjust and increase the proximately radius (e.g., 3 miles or 5 miles) based on the average speed, for example, at block 1320. In other words, the system can be configured to dynamically predict how far the user may travel over the next 15 minutes and adjust the proximity radius encompass possible business locations that the user would intersect within that time period.

Moreover, at block 1325, the method can be configured to dynamically adjust the shape of the geofence based on the determined trajectory of the user. Block 1325 is shown in dashes to illustrate it is an optional step. In this case, if the system determines that the user is in a car driving as described above, the system may adjust the geofence such that the shape encompasses business that are only of outward projecting businesses. For example, as shown in FIG. 2, user device 1 is shown to be in the middle of geofence 250. This shape may be acceptable for a user that is walking in a city where the user can easily change directions and even go backwards. However, a user driving in a car (especially on the highway) will be unlikely and/or unwilling to go backwards. Therefore, the system at block 1325 may adjust the shape of the geofence to account for the trajectory. For example, if user device 3 in FIG. 2 is considered to be heading north (e.g., in the upwards direction of the page), the geofence 250 is configured as a shape that only encompasses potential business that may intersect the expected path of the user.

Yet further, at block 1330, the method may further be configured to automatically adjust the radius based on additional external business generating data, such as real-time foot traffic, user engagement, time, weather and commercial events. That is, server 210 may be configured to collect this data from third-party sources, such weather and data services, or the specific business themselves that are providing information on food traffic. Based on this data, the system may be configured to dynamically adjust the proximity radius to account for these external business driving data.

At block 1335, a customized advertisement may be generated based on the external business generating data and for any business that falls within the adjusted proximity zone as determined at blocks 1320, 1325 and/or 1330. For example, if the system determines based on the user profile that the user is a “coffee drinker” and it is early in the morning (e.g., 7 am), the system may identify a coffee shop, such as Starbucks®, that is within the adjusted proximity radius and also that may have light foot traffic (or other waiting time) at the current time. The advertisement may be transmitted to the user to prompt the user to stop at the coffee shop and indicate that the waiting time is less than a predetermined threshold, such as five minutes. In yet a refinement of this aspect, the system may also enable the user to invoke an automatic purchase by offering customized advertisements of the type of coffee known that the user likes, so that the user can preorder the coffee with a simple click.

Another example may be if the user is walking through a town (e.g., on holiday) and the weather indicates that it will begin raining soon. The proximity radius may be adjusted to account for all restaurants or taverns that the user can walk to (based on the determined trajectory) before it starts raining. Using this smart proximity boosting technique by dynamically and automatically adjusting the proximity radius, the system can enable businesses and users to optimize their reach without wasting budget or inefficiencies of unwanted advertisements.

In yet a refinement of the exemplary method shown in FIG. 13, block 1335 can also be modified to prioritize different types of advertising based on the distance and trajectory of the user. As described above, the generated trajectory of the user can be used to determine the direction and distance the user will be from the current point at a given time. In an exemplary aspect, the system (e.g., server 210) can be configured determine a threshold (e.g., based on time) for businesses the user will encounter in view of his or her trajectory. For example, if the user will encounter businesses within the predetermined time threshold (e.g., 30 minutes), the system may be configured to generate a first type of advertising (e.g., flash sales) whereas if the user will encounter businesses outside of the predetermined time threshold (e.g., 30 minutes), the system may be configured to generate a second type of advertising (e.g., long-rang advertising for general branding). This layered advertising based on proximity enables the system and method described herein to provide a more

In accordance with various aspects of this disclosure, one or more of the following features may be provided.

Precision Targeting: The system and method enable pinpoint accuracy allows for delivery of hyper-localized and targeted advertisements, ensuring that users receive offers relevant to their immediate surroundings.

Real-Time Engagement: Users receive timely and contextually relevant promotions, enhancing the likelihood of conversion by presenting offers when they matter most.

User-Friendly Experience: With a focus on seamless integration, the proposed location-based mobile advertising service enhances the overall user experience, providing valuable content without intrusion.

Advertising Partner Network: A diverse range of advertising partners strategically positioned within a geofence implementing, for example, a 150-meter or other sized radius or shape, can create creating a dynamic ecosystem for targeted promotions.

Data Privacy: In an aspect, the proposed location-based mobile advertising service offers a one-way data set to safeguard user data, ensuring APN analytics can be provided for user interactions without unveiling intact user profile data.

In accordance with various aspects of this disclosure, one or more of the following benefits may be obtained:

Increased Foot Traffic: The proposed location-based mobile advertising service drives users to the physical locations of advertising partners, boosting foot traffic and encouraging real-world engagement.

Higher Conversion Rates: The contextual relevance of offers delivered in proximity to users increases the likelihood of conversions, maximizing the impact of advertising campaigns.

Enhanced Brand Visibility: The proposed location-based mobile advertising service establishes a stronger presence in the local market by reaching users when they are most likely to interact with your brand.

Data-Driven Insights: Leverage comprehensive analytics to gain valuable insights into user behavior, campaign performance, and overall ROI.

In accordance with various aspects of this disclosure, one or more of the following geolocation systems may be used:

GPS (Global Positioning System): The proposed location-based mobile advertising service may utilize the GPS hardware embedded in smartphones to obtain accurate location data.

Assisted GPS (A-GPS): The proposed location-based mobile advertising service uses assisted GPS to improve location accuracy, especially in urban areas or areas with weak GPS signals, by combining satellite data with other sources.

WI-FI Positioning System: The proposed location-based mobile advertising service uses WI-FI signals to triangulate the user's position, which is particularly effective in indoor environments.

In accordance with various aspects of this disclosure, server-side development may involve one or more of the following:

Backend Framework that includes a scalable database configured to store: (i) user profiles, (ii) location history, (iii) Advertising partner information (including Ad Demographics, Creative assists, Ad frequency, Offer frequency, Client API integration or CTA's for offer purchases and the like), and (iv) geospatial Database Extensions: Relating to or denoting data that is associated with a particular location. For efficient storage and retrieval of geospatial data. In other words, the businesses are generally in a fixed geolocation while the user's location and trajectory can be determined according to the methods described herein. This information can then be used to determine the relevant and targeted business within the defined and dynamically adjustable geofence.

As further described herein, the system and method described herein provides for an advertising partner integration, which essentially can be considered an APN (Advertising Partner Network) Access Dashboard in which an advertising partners interface or backend system enables businesses to view and/or create targeted offers and retrieve relevant user impression data based on the various parameters described herein.

It should be appreciated that various monetization models can be implemented using the methods and systems described herein. For example, a Cost-Per-Click (CPC) system can be implemented where the advertisers (e.g., the business) pay a fee each time a user clicks on their advertisement. This enables the advertisers to only pay for actual engagement with their content, and it is a measurable metric. In another example, the system and method is suitable for campaigns aiming to drive traffic to the advertiser's website or app, such as Cost-Per-Meter (CPM), where the advertisers (e.g., the business) pay a fee for every 1,000 impressions (views), for example, of their ad, regardless of clicks. In another example, a Cost-Per-Action (CPA) is implemented where advertisers (e.g., the business) pay when a specific action(s) is (are) completed, such as, for example, but not limited to, a download, sign-up, or (and) a purchase.

Yet further, the system and method described herein can provide for revenue sharing arrangements, such as a percentage-based revenue share where the advertising platform takes a percentage of the revenue generated through advertisements served on the platform. This arrangement would align the platform's success with the success of its advertising partners, of which the approach is suitable for platforms that provide a comprehensive suite of services. In another example, a fixed-fee revenue share percentage of ad spend typically 10%-15%, in which advertising partners pay a fixed fee or percentage on the revenue generated or ad spend whichever is greater, regardless of the total amount of views within a campaign period.

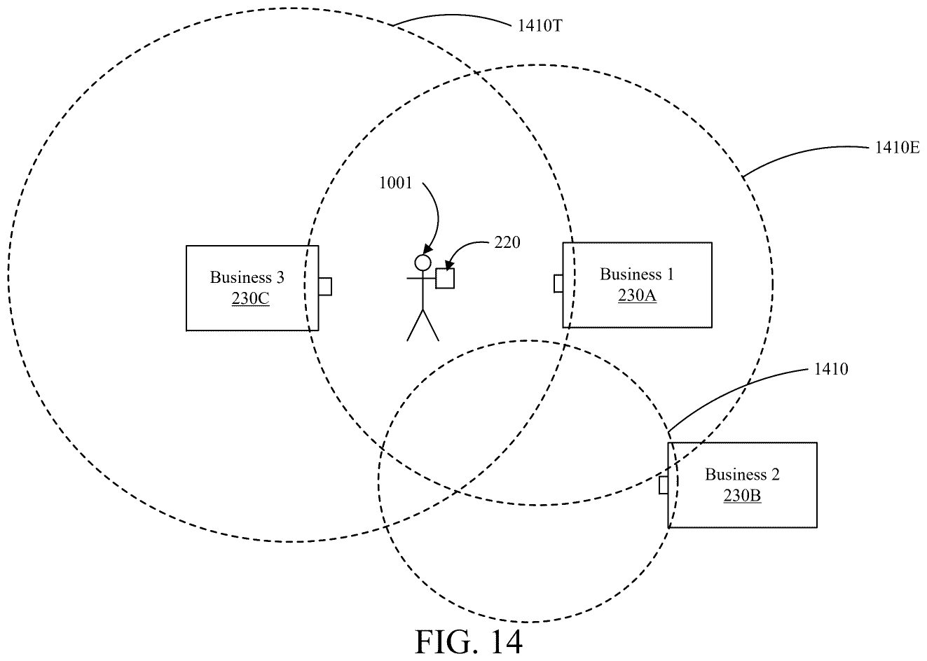

Referring now to FIGS. 14-21, various embodiments are described directed to filtering data (e.g., a database) to reduce the amount of data to pertinent data before transmitting the data to a user device. In an aspect, a filter is installed at a server that is remote from a user device and performs filtering based on a location of the user device with customizable filtering specific to each end user as determined, e.g., from user profile data in a user database.

In an aspect, FIG. 14 pertains to a geofence 1410 and extended geofences 1410E and 1410T. In an aspect, the geofence 1410 is for proximity-based mobile advertising. In an aspect, the extended geofences 1410E and 1410T are for proximity-based mobile advertising using time-limited proximity boosts.

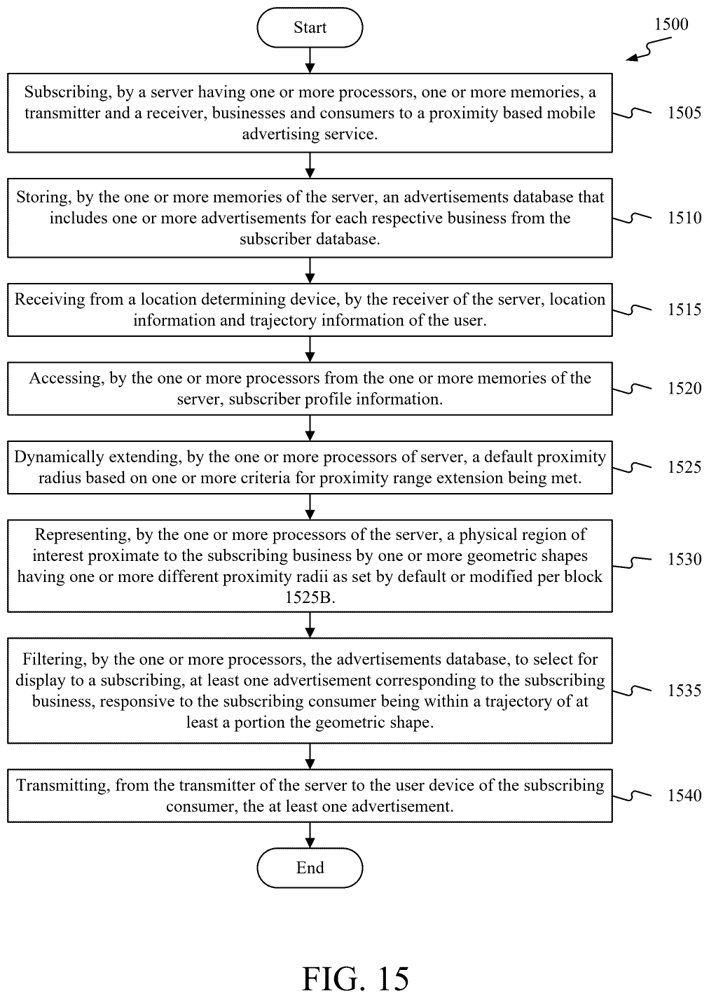

In an aspect, FIGS. 15-19 pertain to adjusting the geofence or proximity radius using time-limited proximity boosts. By filtering a database of advertisements, only advertisements pertaining to businesses within a region of interest proximate to a user will be transmitted to the user device.

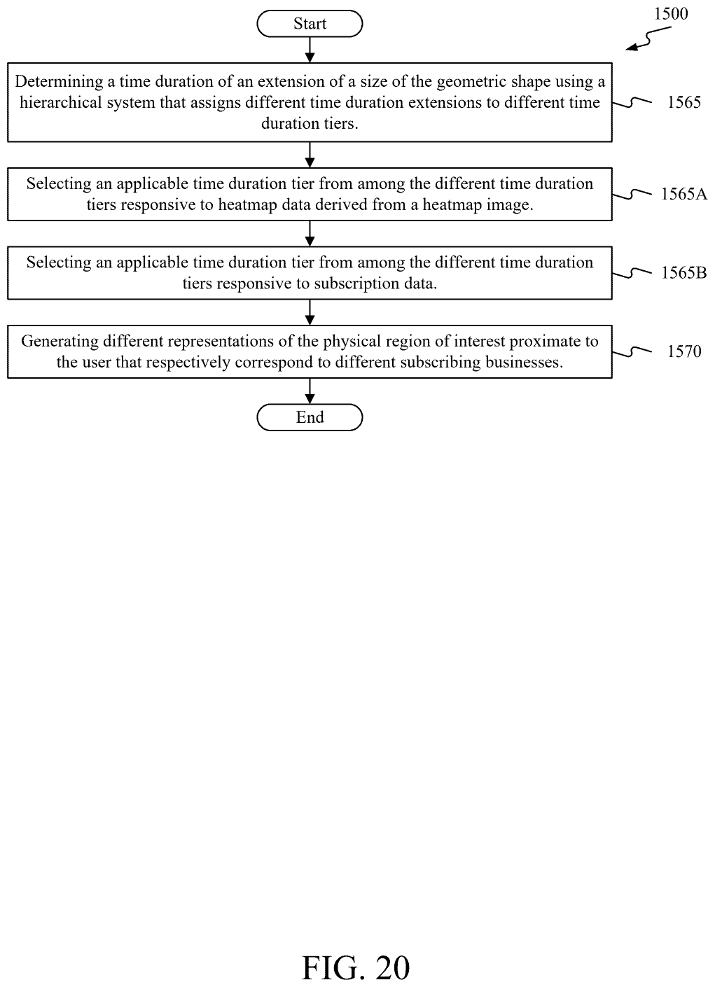

In an aspect, FIG. 20 illustrates a method for proximity-based event and content access. The method provides exclusive digital content to the user device of a user by filtering a database of exclusive digital content corresponding to multiple subscribing businesses. In an aspect, the filtering is based on a subscribing business being within a trajectory of at least a portion the geometric shape. In an aspect, the filtering is further based on user preferences, for example, with respect to a type (e.g., audio and/or video and/or so forth) of exclusive digital content the user is amenable to receiving.

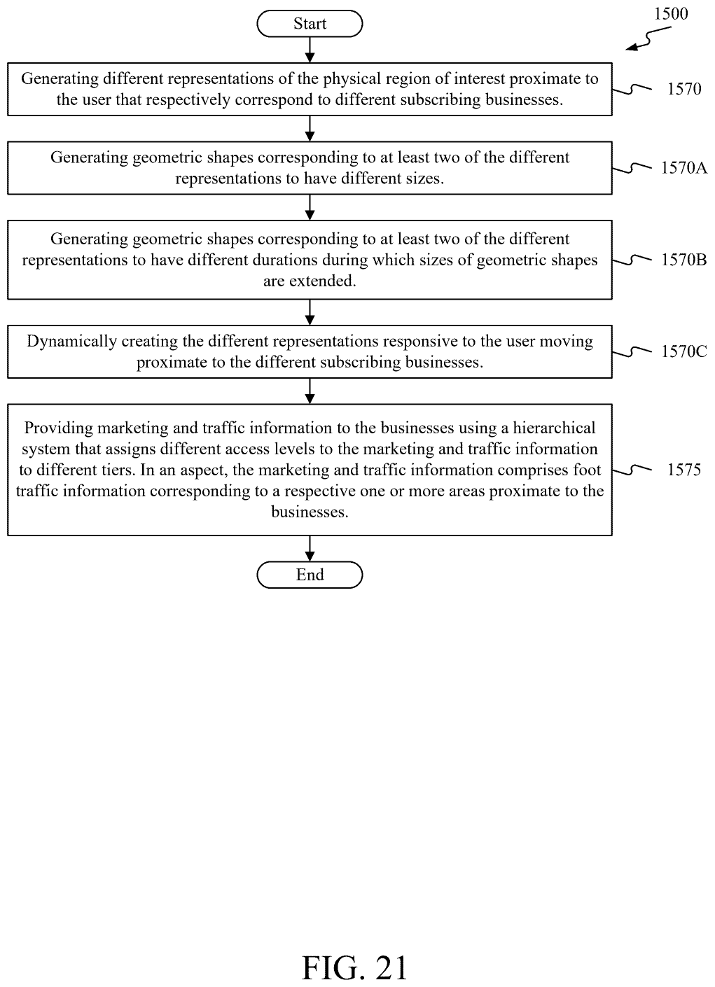

In an aspect, FIG. 21 illustrates a method for adjusting the geofence or proximity radius using heat-map based time-limited proximity boosts

Referring to FIG. 14 illustrates geofence 1410 and extended geofences 1410E and 1410T, the latter two for proximity-based mobile advertising using time-limited proximity boosts.

In an aspect, subscribing businesses are allowed to temporarily expand their reach for set time periods. This is implemented by extending the geofence used by a subscribing business with respect to consumers within the geofence. That is, that business is able to be “seen” from a further distance than otherwise due to the business subscribing to use a proximity-based mobile advertising service that uses time-limited proximity boosts. Thus, for consumer members of an application that receive targeted advertisements for the consumer based on the consumer's preferences, those preferences can be exploited in that matching businesses to the consumer's preferences can “reach” the consumer when the user is a further distance away from the business than a default or typically used range. This enables the business to potentially expand their sales by having more advertisement sent to consumers due to the fact that the pool of consumers that receive advertisement has increased based on the use of an increased proximity range between the business and the potential consumer, namely the geofence as described herein.

A geofence defines a boundary that around one or more entrances to a business. In this aspect, a subscribing consumer may have multiple geofences assigned to them. For example, a default geofence involving a default distance or proximity radius may be used for some businesses while for one or more other businesses, one or more respective extended geofences may be used for one or more respective temporary periods of time, where each of the one or more extended geofences has an extended distance or extended proximity radius compared to a non-extended geofence. What that means is that the distance from a business to a potential consumer can be larger and the potential consumer can receive advertisements that only closer potential consumers typically receive. This can provide the impetus for the potential consumer to travel the further distance to arrive at the business using a time-limited proximity boost and consummate a sale.

For example, a geofence 1410 can be temporarily enlarged to form a geofence 1410E and/or 1410T for a set time-period (e.g., an hour). In an aspect, geofence 1410E and geofence 1410T provide subscribing consumers who are further away from a subscribing business with advertisements for the subscribing business versus a shorter reach or range of geofence 1410. For example, while a default proximity radius of geofence 1410, corresponding to a distance from the subscribing business to a point on the periphery of the geofence, can be set by the subscribing business or the system and can be 150 meters, that proximity radius of geofence 1410 can be extended to 250 meters for a limited period of time to implement extended geofence 1410E or to 300 meters for a limited period of time to implement extended geofence 1410T. In this way, subscribing businesses can have users within extended geofences 1410E and 1410T receive advertisements they would not have otherwise received if default geofence 1410 was used.

The geofence extension can be implemented based on various geofence extension criteria. In an aspect, the various geofence extension criteria can include or be based on, for example: a pay-to-extend subscription policy; target sales (e.g., extension resulting from only reaching a minimum sale goal versus a target higher sale goal, e.g., for a subscription based on a minimum amount of sales); a reward system (e.g., extension resulting from a reward system for higher sales); and so forth. As a further example relating to a pay-to-extend subscription policy, the more a business pays, the further their reach in extending the proximity radius and/or the longer the reach is kept in effect for. Of course, other basis can also be used for the geofence extension criteria.

In an aspect, a subscribing consumer can traverse a space, such as, for example, a mall, a shopping center, or a street, where there are multiple business proximate to the subscribing consumer, and where such traversal can involve the use of multiple geofences, for example, default geofence 1410 and extended geofences 1410E and 1410T. In further detail, business 1 23A may simply subscribe for the use of default geofence 1410 with respect to subscribing consumers, while business 2 230B may subscribe for the use of extended geofence 1410E, and business 3 230C may subscribe for the use of extended geofence 1410T. As shown, only business 1 230A is within geofence 1410, while business 1 230A and business 3 230C are within geofence 2 1410E, and business 1 230A, business 2 230B, and business 3 230C are within geofence 1410T. Thus, as can be seen, various extensions of a user's geometric range extend the reach of businesses (e.g., business 2 230A and business 3 230A) proximate to the user 1001.

In an aspect, a cooldown period prevent spam and keeps things fair.

The geometric shape can be a circular or non-circular. In an aspect, the proximity radius of a geometric shape that is non-circular refers to a distance from the center of the geometric shape to a random point of the geometric shape from the center of the geometric shape. In another aspect, the proximity radius of a geometric shape that is non-circular refers to a distance from the center of the geometric shape to a furthest point of the geometric shape from the center of the geometric shape (e.g., for a pointed star having equal length points, the distance from the center of the star to any tip or end of the point of the star). In yet another aspect, the proximity radius of a geometric shape that is non-circular refers to a distance from the center of the geometric shape to a closest point of the geometric shape from the center of the geometric shape (e.g., for the star, the distance from the center of the star to any location on the geometric shape periphery that is not part of a projection of the star, i.e., not part of a point). In a still further aspect, the proximity radius of a geometric shape that is non-circular refers to a distance from the center of the geometric shape to an average between a furthest point of the geometric shape from the center of the geometric shape and a closest point of the geometric shape from the center of the geometric shape. It is to be appreciated that for many geometric shapes, there may be multiple furthest points equally far from the center of the geometric shape, as well as multiple closest points equally close to the center of the geometric shape.

In an aspect, the center of the geometric shape may not coincide to the center of the business. In an aspect, an area close to a periphery or the periphery of the geometric shape itself may be placed with respect to an entrance to a business as shown in FIG. 14 in order to enlarge the scope of reach as now in the case of a circle, the further distance from the business door is not the radius R, but rather 2R or the diameter D.

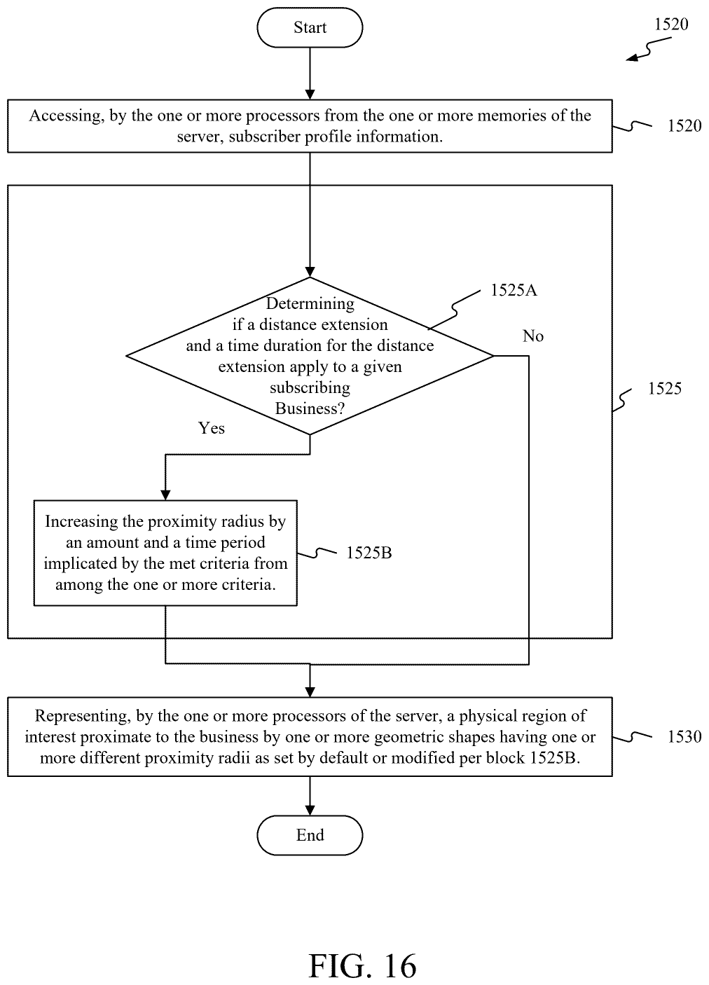

Referring to FIG. 15, a method 1500 for adjusting the geofence or proximity radius using time-limited proximity boosts is shown according to an exemplary aspect. Referring to FIG. 16, further detail on block 1525 of method 1500 of FIG. 15 is shown according to an exemplary aspect.

At block 1505, method 1500 includes subscribing, by a server 210 having one or more processors 210A, one or more memories 210B, a transmitter 210C and a receiver 210C, businesses and consumers to a proximity based mobile advertising service. Subscriber profile information can be stored in private cloud 106 and can be customized by the user. In an aspect, the service may be provided to subscribing consumers and/or subscribing businesses via one or more applications such as application on a mobile device 220 of a subscribing consumer and a mobile device of subscribing authorized business personnel.

In an aspect, subscribing means associating subscribers with a role, from among consumer or business, and obtaining information relating to the role. For example, for consumers, the information relating to the role (aka consumer information) may include interests of the consumer including items the consumer is interested in, e.g., purchasing, prior purchasing history, and so forth. For a business, the information relating to the role (aka business information) may include business name, business hours, local map indicating the business, forms of payment accepted by the business, items for sale by the business and/or services provided by the business, and so forth.

Moreover, for a business, the information may include a request or subscription for a geofence extension (e.g., to go from geofence 1410 to extended geofence 1410T for a temporary period of time). The consumer information and the business information may be used to build respective subscriber profiles for corresponding subscribers that may be later accessed to determine, e.g., if a business has subscribed to a geofence extension.

As described above, the distance implemented by the geofence 250 generally is configured to coincide with a typical range (e.g., a predetermined range) and in a direction (i.e., a trajectory) that may possibly cross the subscribing consumers personal space or that may overlap with or get close to the subscribing consumer's personal space. However, in this aspect, the geofence or proximity radius may be automatically and/or dynamically extended to optimize the business's reach to a target customer.

At block 1510, method 1500 includes storing, by the one or more memories 210B of the server 210, an advertisements database that includes one or more advertisements for each respective business from the subscriber database.

At block 1515, method 1500 includes receiving from a location determining device, by the receiver 210C of the server 210, location information and trajectory information of the user. In an aspect, the trajectory information can include the current location of the user and a prediction path of X steps likely to be taken next by the subscriber, where X is an integer. It should be appreciated that the trajectory can include both direction and speed, which can both factor in to maintaining the position of a geometric shape relative to the user for implementing a proximity radius.

At block 1520, method 1500 includes accessing, by the one or more processors 210A from the one or more memories 210B of the server 210, subscriber profile information. For subscribing consumers, the subscriber profile information can include, but is not limited to, gender, age, buying habits, interests (which may be customized by the subscriber), available funds for spending in one or more accounts or available on one or more types of cards such as credit and/or debit cards and the like. For subscribing businesses, the subscriber profile information can include a subscription for geofence extension. In an aspect, the subscription for geofence extension may include identification of one or more tier levels corresponding to size extension tiers and/or time duration tiers.

In an aspect, different tiers can correspond to different extended proximity radii and different temporary time periods during which to extend the different extended proximity radii are implemented.

For example, a tiered hierarchy of proximity radii may be used where a default proximity radius of 150 meters is initially used. A first tier may involve extending the proximity radius to 200 meters for a temporary period of time. A second tier may involve extending the proximity range to 250 meters for a temporary period of time. A third tier may involve extending the proximity range to 300 meters for a temporary period of time. These distances are exemplary and other distances and numbers of tiers can be used. In an aspect, subscribing business pay more to obtain a higher tier status for their proximity radius. In an aspect, jumps from other than the default proximity range can be made. For example, considering the preceding example, a subscribed business may jump from the first tier (200 meters) to the third tier (300 meters), bypassing use of the second tier (250 meters).

It is to be appreciated that the extension of proximity radius is for a temporary period of time. In an aspect, this temporary period of time can also be system adjusted based on a subscription status of the subscribing business. For example, the period of time for the extension of the proximity radius can be tiered similar to as the distance was described above as tiered. Each level in a hierarchy of time duration tiers may involve a longer time period for an extension of the proximity radius than a preceding tier. Thus, for example, for the first tier from the preceding example the extension of the proximity radius to a first distance (e.g., 200 meters) can be for a first time duration (e.g., 30 minutes), while for the second tier the extension of the proximity radius to a second distance>first distance (e.g., 250 meters) can be for a second time duration (e.g., 60 minutes), and for the third tier the extension of the proximity radius to a third distance>second distance (e.g., 300 meters) can be for a third time duration>second time duration (e.g., 90 minutes). In this way, different fees can be charged for different temporary extensions of the proximity radius for different periods of time.

However, it is to be appreciated that the temporary time periods assigned per tier are not constrained to being fixed and can also be variable. For example, in an aspect, time durations may be tiered so that a first tier corresponds to extending the proximity radius for a first time duration (e.g., 30 minutes), a second tier corresponds to extending the proximity radius for a second time duration>first time duration (e.g., 60 minutes), and a third tier corresponds to extending the proximity radius for a third time duration>second time duration (e.g., 90 minutes). In an aspect, different tier levels for the proximity range can be combined with different tier levels for the time duration. For example, a user may select to extend the proximity distance to 200 meters for 90 minutes, corresponding to the first tier of the distance extension tiers and the third tier of the time duration tiers.

As noted above, the initial proximity radius may be a predefined or default distance (e.g., 150 meters). At block 1525, method 1500 including dynamically extending, by the one or more processors 210A of server 210, a default proximity radius based on one or more criteria for proximity range extension being met. For example, if the default proximity radius is 150 meters, the system may increase the proximity radius to 250 meters (second tier) for a period of time (e.g., corresponding to a time duration tier) to better increase the chance of a sale by including more people further away from a business than if 150 meters is used as the proximity radius. The criteria may involve a request for a proximity radius extension involving a distance extension to the proximity radius and a time duration during which the distance extension is to be applied.

In an aspect, block 1525 includes blocks 1525A and 1525B referred to and shown in FIG. 16.

At block 1525A, method 1500 includes determining if a distance extension and a time duration for the distance extension apply to a given subscribing business. The determination may be based on information in the subscribing businesses subscriber profile information. The information may indicate a subscription for one or more distance extensions and corresponding time durations during which the distance extensions are employed. If so, method 1500 proceeds to block 1525B. Otherwise, method 1500 proceeds to block 1525.

At block 1525B, method 1500 includes increasing the proximity radius by an amount and a time period implicated by the met criteria from among the one or more criteria. For example, the proximity radius may be increased by an amount and a time period corresponding to any tiers subscribed to by a business subscriber.

At block 1530, the method 1500 includes representing, by the one or more processors 210A of the server 210, a physical region of interest proximate to the subscribing business by one or more geometric shapes having one or more different proximity radii as set by default or modified per block 1525B. For a subscribing consumer, the physical region of interest proximity to the user is determined based on the location information, the trajectory information, and subscription information relating a temporary proximity radius extension.

In an aspect, block 1530 involves the one or more processors 210A of the server 210 using the location information and trajectory information of the user to keep the proximity radius formed in a relative fixed position with respect to the user. For example, for a circle as the geometric shape, the center of the circle or a point on the circumference of the circle may be positioned at the location of an entrance of a business. The former provides a reach equal to the radius R of the circle, while the latter can provide a reach equal to the diameter D of the circle.

At block 1535, the method 1500 includes filtering, by the one or more processors 210A of the server 210, the advertisements database, to select for display to a subscribing consumer, at least one advertisement corresponding to the subscribing business, responsive to the subscribing consumer being within a trajectory of at least a portion the geometric shape. In an aspect, the advertisement is selected based on the subscriber profile information, including business information and/or consumer information. For example, an advertisement may match an item for sale to previous purchases by the subscribing consumer, interests (e.g., in types of items (e.g., clothing, food, events, furniture, electronics, etc.) of the subscribing consumer, and/or an amount of credit available to the subscribing consumer or in the subscribing consumer's checking account.

At block 1540, method 1500 includes transmitting, from the transmitter 210C of the server 210 to the user device 220 of the subscribing consumer, the at least one advertisement.

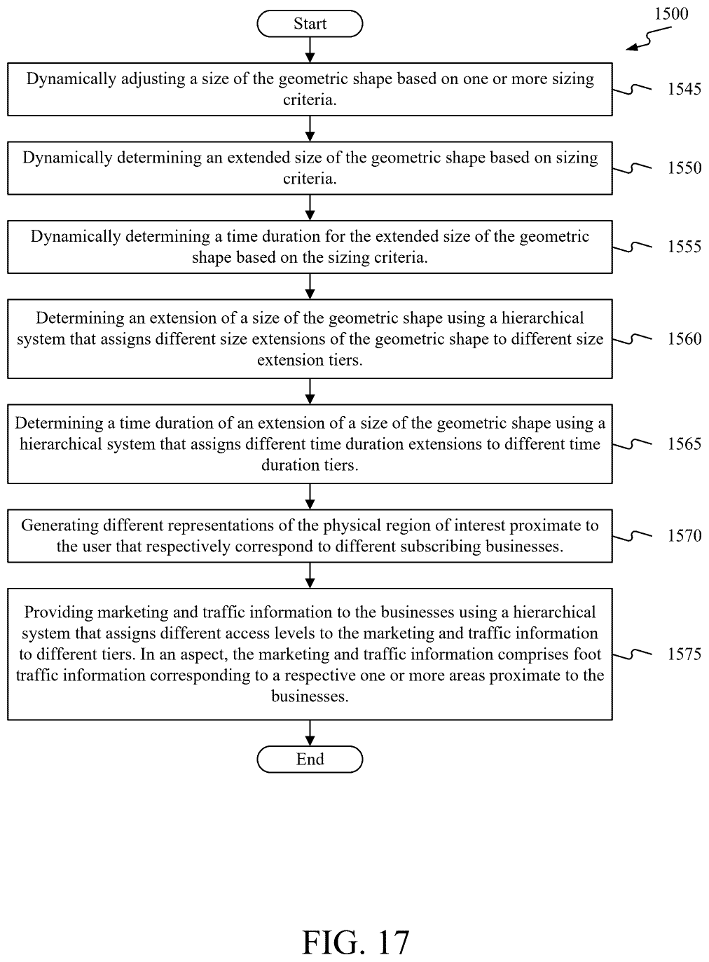

Referring to FIGS. 17-21, further blocks of method 1500 are shown, in accordance with an example aspect.

At block 1545, the method includes 1500 dynamically adjusting a size of the geometric shape based on one or more sizing criteria. In an aspect, the sizing criteria can include one or more of subscription information, imaging device information (including thermal imaging devices), and so forth.

At block 1550, the method 1500 includes dynamically determining an extended size of the geometric shape based on sizing criteria. For example, in an aspect, the extended size of the geometric shape based on one or more of subscription information and/or imaging device information (including thermal image devices). In an aspect, the subscription information may specify a size or sizes under different circumstances (time of day, holiday/non-holiday, etc.). In an aspect, the imaging device information includes heat map data indicating a set of human heat sources having temperatures compared to threshold levels and/or ranges to distinguish human heat sources from other heat sources. In an aspect, a shape may be determined to optimize (maximize) a number of people within the given radius of the shape.

At block 1555, the method 1500 includes dynamically determining a time duration for the extended size of the geometric shape based on the sizing criteria. In an aspect, the time duration may be specified in subscription information. In an aspect, the time duration may be determined relative to a number of human heat sources in a heat map. For example, at times when heat map data indicates a human density higher than a threshold(s), the size of the geometric shape may be extended or further extended.

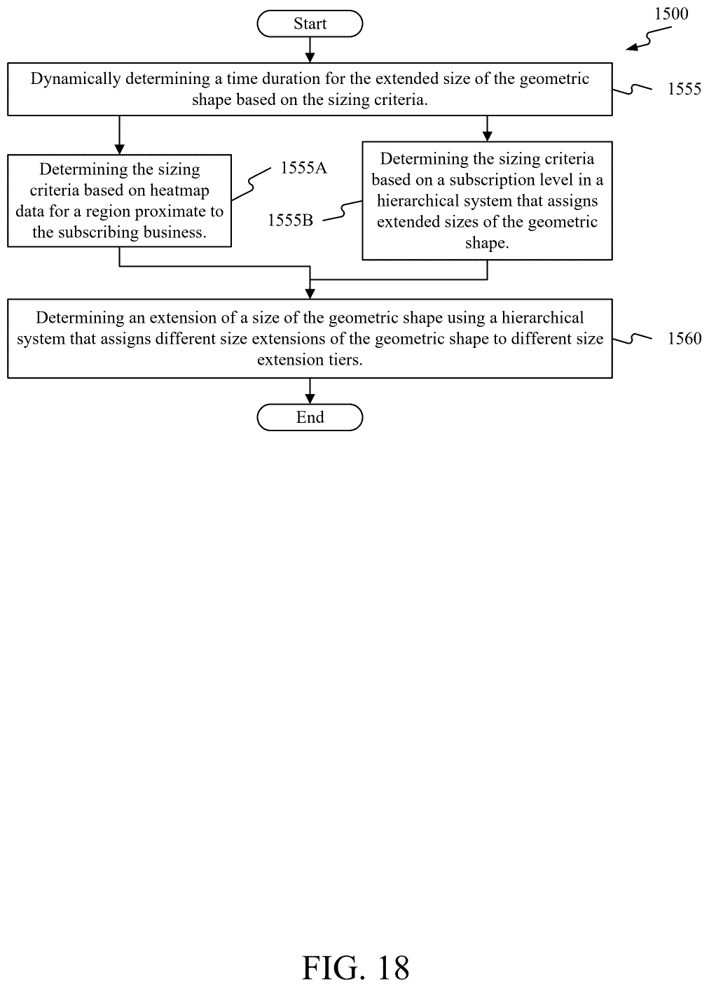

In an aspect, block 1555 may include one or more of blocks 1555A and B referred to and shown in FIG. 18.

At block 1555A, the method 1500 includes determining the sizing criteria based on heatmap data for a region proximate to the subscribing business. For example, in an aspect, the sizing criteria is increased when the heatmap data indicates a number of human heat sources greater than one or more thresholds.

At block 1555B, the method 1500 includes determining the sizing criteria based on a subscription level in a hierarchical system that assigns extended sizes of the geometric shape. For example, each tier may extend a given geometric shape more than a preceding tier.

At block 1560, the method 1500 includes determining an extension of a size of the geometric shape using a hierarchical system that assigns different size extensions of the geometric shape to different size extension tiers.

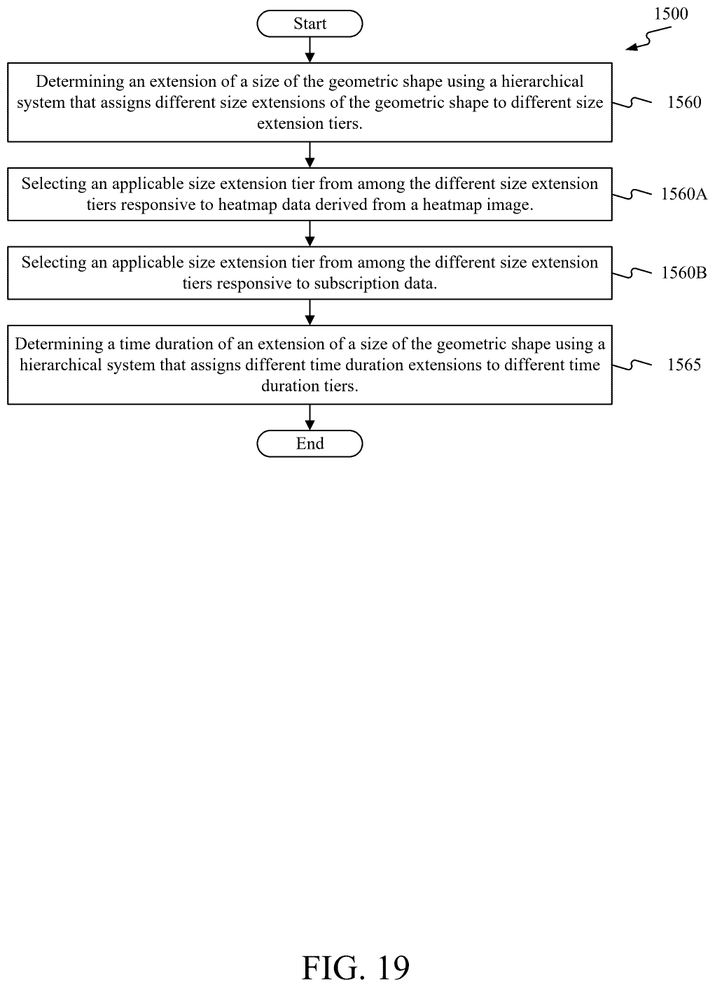

In an aspect, block 1560 may include one or more of blocks 1560A and 1560B referred to and shown in FIG. 19.

At block 1560A, the method 1500 includes selecting an applicable size extension tier from among the different size extension tiers responsive to heatmap data derived from a heatmap image.

At block 1560B, the method 1500 includes selecting an applicable size extension tier from among the different size extension tiers responsive to subscription data.

At block 1565, the method 1500 includes determining a time duration of an extension of a size of the geometric shape using a hierarchical system that assigns different time duration extensions to different time duration tiers.

In an aspect, block 1565 may include one or more of blocks 1565A and 1565B referred to and shown in FIG. 20.

At block 1565A, the method 1500 includes selecting an applicable time duration tier from among the different time duration tiers responsive to heatmap data derived from a heatmap image.

At block 1565B, the method 1500 includes selecting an applicable time duration tier from among the different time duration tiers responsive to subscription data.

At block 1570, the method 1500 includes generating different representations of the physical region of interest proximate to the user that respectively correspond to different subscribing businesses.

In an aspect, block 1570 may include one or more of blocks 1570A through 1570C referred to and shown in FIG. 21.

At block 1570A, the method 1500 includes generating geometric shapes corresponding to at least two of the different representations to have different sizes.

At block 1570B, the method 1500 includes generating geometric shapes corresponding to at least two of the different representations to have different durations during which sizes of geometric shapes are extended.

At block 1570C, the method 1500 includes dynamically creating the different representations responsive to the user moving proximate to the different subscribing businesses.

At block 1575, the method 1500 includes providing marketing and traffic information to the businesses using a hierarchical system that assigns different access levels to the marketing and traffic information to different tiers. In an aspect, the marketing and traffic information comprises foot traffic information corresponding to a respective one or more areas proximate to the businesses.

A description will now be given regarding various aspects relating to proximity-based event and content access.

In an aspect, subscribers can be provided exclusive digital content on their mobile devices based on the locations of the subscribers.

Exclusive digital content can range from digital passes or digital tickets to VIP or other limited access events, early access to products, behind-the-scenes content, limited-edition items, limited access deals, and special discounts, all reserved for a specific group or audience that is determined based on location, that is, proximity to a reference point. The events, products, and limited-edition items may be physical items or digital items.

In an aspect, subscriber profile information may be used to ensure the subscriber is targeted to receive exclusive digital content for things of interest to the subscriber as indicated in the subscriber's profile. For example, for a subscriber walking the streets of New York City, where there are many different entertainment venues and stores, the subscriber is limited to receiving exclusive digital content only for venues and stores within a proximity radius of the subscriber, and only for items of interest to the user. Thus, if a subscriber user only likes Jazz music, then the subscriber will not be directed to venues that only features Rock music. Rather, the user will receive exclusive digital content including digital passes or tickets, digital media including multimedia and so forth relating to local (i.e., within the proximity radius) venues, stores, and so forth. In this way, the exclusive digital content is essentially determined based on the location of the user relative to a reference point associated with the exclusive digital content and the interests of the user. This ensures that the user is provided with relevant information within a distance within which the user can act (e.g., purchase any items offered for sale to the subscriber based on the subscriber's location and the subscriber's interests).

In an aspect, subscribers must be within a specific proximity radius to a reference point (e.g., a venue, a business, etc.) to claim the exclusive digital content, minimizing fraud. Moreover, in this way, the consumption of the exclusive digital content can be expedited due to a consumer being proximate to an item (e.g., a venue, a business, etc.) corresponding to the exclusive digital content and thus wanting to view the exclusive digital content contemporaneously with being located proximate to the item (e.g., a venue, a business, etc.).

The exclusive digital content can be, for example, but is not limited to, audio content and/or video content and/or digital access to physical content.

In an aspect, the subscribing business is an entertainment venue (bar, pub, concert area, stadium, museum, etc.). In an aspect, the exclusive digital content can relate to a performer at the venue, whether in the past, currently, or in the future.

In an aspect, the subscribing business is a museum. In an aspect, the exclusive digital content can relate to a current or permanent showing at a museum. For example, in any aspect, further information on items in the museum and/or related items can be provided as the exclusive digital content.

In an aspect, the subscribing business is a store. In an aspect, the exclusive digital content can relate to items for sale in the store including limited edition items, limited access deals and so forth.

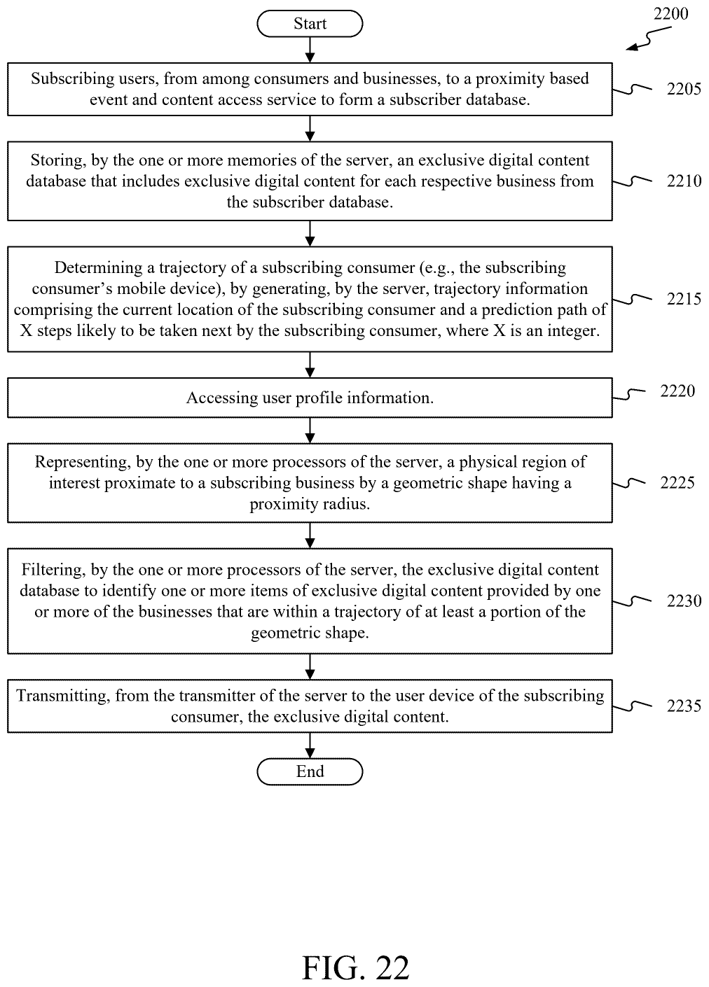

Referring to FIG. 22, a method 2200 for proximity-based event and content access is shown according to an exemplary aspect.

At block 2205, method 2200 includes subscribing users, from among consumers and businesses, to a proximity-based event and content access service to form a subscriber database.

In an aspect, subscribing can mean identifying users (consumers) who want to receive proximity-based event and content access and identifying users (businesses) who wants to provide proximity-based event and content access. In this way, proximity-based event and content access can be provided to the consumers by the business.

In an aspect, subscribing can further mean collecting information corresponding to each subscriber. In an aspect, subscribing can further mean associating users with user interests so that businesses can target consumers with similar interests when offering exclusive digital content to those consumers within a proximity radius of a reference point such as a business location.

For a business, business information that may be provided while subscribing includes, but is not limited to, one or more of: business name; business operating hours; local map indicating the business location; forms of payment accepted by the business; items for sale by the business; upcoming events occurring at the business, and so forth.

For a consumer, consumer information that may be provided while subscribing includes, but is not limited to, one or more of: user name; forms of payment capable of being made; user interests for events, purchases, rentals, and/or other items the user is interested in receiving exclusive digital content for; an amount of money the user typically spends in one buying session; and so forth.

The consumer information and the business information may be used to build respective user profiles for corresponding users that may be accessed to determine user interests to match to businesses within a proximity radius of the user as the user is traversing. The user profiles can be stored in private cloud 106 and can be customized by the user.

The distance implemented by the geofence 250 generally is configured to coincide with a typical range (e.g., a predetermined range) and in a direction (i.e., a trajectory) that may possibly cross a subscriber's personal space or that may overlap with or get close to the subscribers personal space.

At block 2210, method 2200 includes storing, by the one or more memories 210B of the server 210, exclusive digital content database that includes one or more advertisements for each respective business from the subscriber database.

At block 2215, method 2200 includes determining a trajectory of a user (e.g., the user's mobile device), which as described above can be determined by generating, by the server 210, trajectory information comprising the current location of the user and a prediction path of X steps likely to be taken next by the user, where X is an integer.

At block 2220, method 2200 includes accessing user profile information, e.g., from the one or more memories 210B of server 210. For subscribing individuals, the user profile information as described above but at the least including user interests in various items (entertainment (artists, music, etc.), food, clothes, electronics, etc.).

At block 2225, the method 2200 includes representing, by the one or more processors 210A of the server 210, a physical region of interest proximate to the user by a geometric shape having a proximity radius. For a consumer user and a business user, the physical region of interest proximity to the user is determined based on the location information and the trajectory information. For the business user, the physical region of interest proximate to the user is further determined based on subscription information relating a temporary proximity radius extension.

In an aspect, block 2225 involves the one or more processors 210A of the server 210 using the location information and trajectory information of the user to keep the proximity radius formed in a relative fixed position with respect to the user. For example, for a circle as the geometric shape, the center of the circle may be positioned at the location of the user.

At block 2230, method 2200 includes filtering, by the one or more processors 210A of the server 210, the exclusive digital content database to identify one or more items of exclusive digital content provided by one or more of the businesses that are within a trajectory of at least a portion of the geometric shape.

In an aspect, the exclusive digital content is identified based on the subscriber profile information, including consumer interests in various items, some of which are identified above. For example, by comparing user interests in the subscriber profile information to metadata of the exclusive digital content, a match to an initial set(s) of exclusive digital content may be identified. In an aspect, this initial set(s) may be very specific to the user interests and may be obtained by performing a comprehensive matching process between the user's interests and the metadata. In another aspect, for the sake of processing speed, the initial set(s) of exclusive digital content may be general and may include content that is potentially outside the user's interests.

Accordingly, in such a case, at block 2230, method 2200 may customize the exclusive digital content based on the subscriber profile information.

For example, in an aspect, an initial exclusive set of exclusive digital content may be processed to highlight and/or otherwise emphasize the most relevant parts of the exclusive digital content based on the subscribing consumer's interests as indicated in the subscribing consumer's subscriber profile. In this way, a subscribing consumer later viewing the entire set of exclusive digital content may readily navigate more quickly to items of likely more interest to the user.

In an example, some digital content in an initial set of exclusive digital content may be filtered out to provide a subset of exclusive digital content that is better tailored to the subscribing consumer to ensure that the exclusive digital content received by the subscribing consumer is limited to only relevant or the most relevant exclusive digital content. In an aspect, exclusive digital content may include various digital media items for consumption or purchase and/or digital access to digital (e.g., music, pictures, videos, etc.) or physical items (photographs, posters, and so forth). For example, for a band, a subscribing consumers may have a preference for some but not at all bandmembers and may want to receive exclusive digital content for only a subset of the bandmembers.

At block 2235, method 2200 includes transmitting, from the transmitter 210C of the server 210 to the user device 220 of the user, the exclusive digital content (e.g., identified at block 2225 and/or customized (e.g., emphasized and/or filtered) at block 2230).

A description will now be given for heatmap-based targeting in according with various aspects of the present disclosure.

In an aspect, a real-time heatmap of an area can be generated to show businesses where to boost their reach based on user density and activity trends. The real-time heatmap can indicate the presence and number of people in the area. The real-time heatmap can be timestamped to indicate the time of data capture. The use of the real-time heatmap gives businesses smarter data on when and where to expand such as times of high population density.

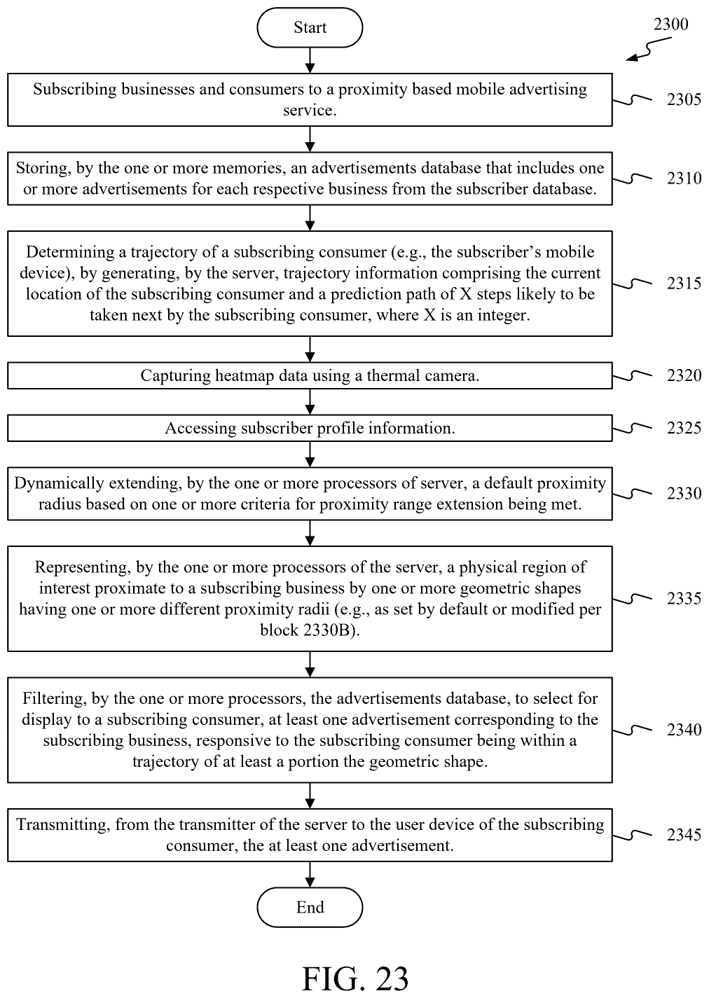

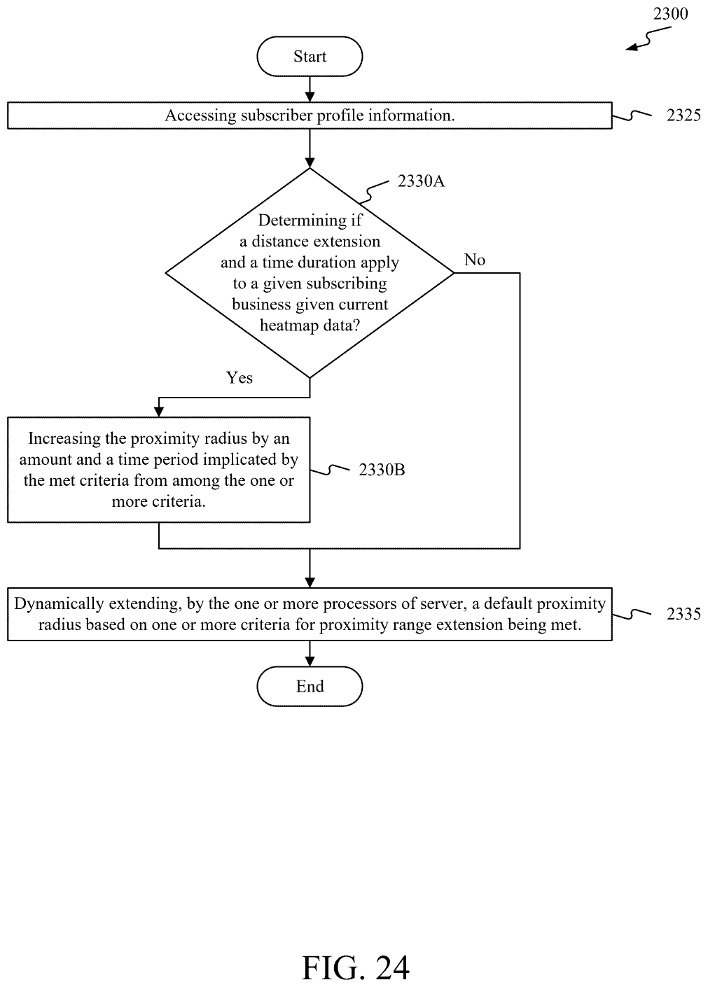

Referring to FIG. 23, a method 2300 for adjusting the geofence or proximity radius using heat-map based time-limited proximity boosts is shown according to an exemplary aspect. Referring to FIG. 24, further blocks of method 2300 are shown, in accordance with an example aspect.

At block 2305, method 2300 includes subscribing businesses and consumers to a proximity based mobile advertising service. In this aspect, the proximity based mobile advertising service uses heat map data to expand a reach of subscribing business. In an aspect, the reach of a subscribing business can be expanded based on the use of an extended proximity radius associated with a subscribing user for the subscribing business. In this way, when more people are within an area at a given time, the higher density of people can be targeted based on determining by using heatmap based that, e.g., a threshold number of people have been reached with respect to being proximate to a given business, causing a signal to be sent to server 210 to expand the geofence of the subscribing consumer with respect to that business. In this way, businesses further than a default proximity radius but with an extended proximity radius can now have their advertisement sent to users within the extended proximity radius with the intent of increasing sales. Subscriber profile information can be stored in private cloud 106 and can be customized by the user. In an aspect, the service may be provided to subscribing consumers and/or subscribing businesses via one or more applications such as application on a mobile device of a subscribing consumer and a mobile device of subscribing authorized business personnel.

In an aspect, subscribing means associating subscribers with a role, from among consumer or business, and obtaining information relating to the role. For example, for consumers, the information relating to the role (aka consumer information) may include interests of the consumer including items the consumer is interested in, e.g., purchasing, prior purchasing history, and so forth. For a business, the information relating to the role (aka business information) may include business name, business hours, local map indicating the business, forms of payment accepted by the business, items for sale by the business and/or services provided by the business, and so forth. Moreover, for a business, the information may include a request or subscription for a geofence extension.

As described above, the distance implemented by the geofence 250 generally is configured to coincide with a typical range (e.g., a predetermined range) and in a direction (i.e., a trajectory) that may possibly cross the subscribing consumers personal space or that may overlap with or get close to the subscribing consumers personal space. However, in this aspect, the geofence or proximity radius may be automatically and/or dynamically extended to optimize the business's reach to a target customer based on heatmap data.

At block 2310, method 2300 includes storing, by the one or more memories, an advertisements database that includes one or more advertisements for each respective business from the subscriber database.

At block 2315, method 2300 includes determining a trajectory of a subscriber (e.g., the subscriber's mobile device), which as described above can be determined by generating, by the server 210, trajectory information comprising the current location of the user and a prediction path of X steps likely to be taken next by the subscriber, where X is an integer. It should be appreciated that the trajectory can include both direction and speed, which can both factor in to determining the size and shape of the proximity radius.

At block 2320, method 2300 includes capturing heatmap data using a thermal camera. In an aspect, the heatmap data includes timestamped images of heat sources in a scene. In an aspect, block 2320 includes processing the heatmap data, e.g., by server 210, to determine a number of human heat sources in a scene and/or area.

At block 2325, method 2300 includes accessing subscriber profile information. For subscribing consumers, the subscriber profile information can include, but is not limited to, gender, age, buying habits, interests, available funds for spending in one or more accounts or available on one or more types of cards such as credit and/or debit cards and the like. For subscribing businesses, the subscriber profile information can include a subscription for geofence extension. In an aspect, the subscription for geofence extension may include identification of one or more tier levels corresponding to one or more of a time duration tier and/or a distance extension tier as described above with respect to FIGS. 15-16. In an aspect, the subscription for geofence extension may include identification of a threshold minimum number of subscribing consumers in relation to the heatmap data.

As noted above, the initial proximity radius may be a predefined distance (e.g., 150 meters). At block 2330, method 2300 including dynamically extending, by the one or more processors 210A of server 210, a default proximity radius based on one or more criteria for proximity range extension being met. For example, if the default proximity radius is 150 meters, the system may increase the proximity radius to an extended distance (e.g., 250 meters, corresponding to distance extension tier) for a period of time (e.g., 60 minutes, corresponding to a time duration tier) to better increase the chance of a sale by including more people further away from a business than if a shorter distance and shorter time (e.g., 150 meters for 30 minutes) is used as the proximity radius. The criteria may involve a request for a proximity radius extension involving a distance extension to the proximity radius and a time duration during which the distance extension is to be applied, where both extensions can be applied responsive to heatmap data such as, for example, a threshold number of people being indicated in the heatmap data for a given region proximate to a subscribing business. The threshold number of people and/or other criteria may be user (subscribing business) settable.

In an aspect, block 2330 includes blocks 2330A and 2330B referred to and shown in FIG. 24.

At block 2330A, method 2300 includes determining if a distance extension and a time duration apply to a given subscribing business given current heatmap data. The determination may be based on information in the subscribing businesses subscriber profile information. The subscriber profile information may indicate a subscription for one or more distance extensions and corresponding time durations during which the distance extensions are employed, as well as threshold numbers (e.g., of people present in a scene and/or an area) that are compared to heatmap data to determine when the proximity radius extensions are to be applied (e.g., when a threshold number of people are present in a scene and/or area). If so, method 2300 proceeds to block 2330B. Otherwise, method 2300 proceeds to block 2335.

At block 2330B, method 2300 includes increasing the proximity radius by an amount and a time period implicated by the met criteria from among the one or more criteria. For example, the proximity radius may be increased by an amount and a time period corresponding to any tiers subscribed to by a business subscriber.

At block 2335, the method 2300 includes representing, by the one or more processors 210A of the server 210, a physical region of interest proximate to the subscriber by one or more geometric shapes having one or more different proximity radii as set by default or modified per block 2330B. For a subscribing consumer, the physical region of interest proximity to the user is determined based on the location information, the trajectory information, and subscription information relating a temporary proximity radius extension when applicable as determined from heatmap data. In an aspect, block 2335 involves the one or more processors 210A of the server 210 using the location information and trajectory information of the user to keep the proximity radius formed in a relative fixed position with respect to the user. For example, for a circle as the geometric shape, the center of the circle may be positioned at the location of the user.

At block 2340, the method 2300 includes filtering, by the one or more processors, the advertisements database, to select for display to the user, at least one advertisement corresponding to a subscribing business, responsive to the subscribing business being within a trajectory of at least a portion the geometric shape. In an aspect, the advertisement is selected based on the subscriber profile information, including business information and/or consumer information. For example, an advertisement may match an item for sale to previous purchases by the subscribing purchaser, interests (e.g., in types of items (e.g., clothing, food, events, furniture, electronics, etc.) of the subscribing purchaser, and/or an amount of credit available to the subscribing purchaser or in the subscribing purchaser's checking account.

At block 2345, method 2300 includes transmitting, from the transmitter of the server to the user device of the subscriber, the at least one advertisement.

A description will now be given regarding various clauses in accordance with various aspects of the present disclosure.

Clause 1. A method for filtering data transmitted to a user device of a user, comprising: subscribing, by a server having one or more processors, one or more memories, a transmitter and a receiver, users from among businesses and consumers, to a proximity-based mobile advertising service, to form a subscriber database that includes location information of subscribing businesses; storing, by the one or more memories, an advertisements database that includes one or more advertisements for each respective subscribing business from the subscriber database; receiving, by the receiver, location information and trajectory information of the user; representing, by the one or more processors based on the location information of a subscribing business, a physical region of interest proximate to the subscribing business by a geometric shape; filtering, by the one or more processors, the advertisements database, to select for display to the user, at least one advertisement corresponding to the subscribing business, responsive to a user trajectory being within at least a portion the geometric shape; and transmitting, by the transmitter to the user device, the at least one advertisement.

Clause 2. The method in accordance with clause 1, further comprising dynamically adjusting a size of the geometric shape based on one or more sizing criteria.

Clause 3. The method in accordance with any preceding clauses, further comprising dynamically determining an extended size of the geometric shape based on sizing criteria.

Clause 4. The method in accordance with any preceding clauses, further comprising dynamically determining a time duration for the extended size of the geometric shape based on the sizing criteria.

Clause 5. The method in accordance with any preceding clauses, further comprising determining the sizing criteria based on heatmap data for a region proximate to the subscribing business.

Clause 6. The method in accordance with any preceding clauses, further comprising determining the sizing criteria based on a subscription level in a hierarchical system that assigns extended sizes to the geometric shape.

Clause 7. The method in accordance with any preceding clauses, further comprising, determining an extension of a size of the geometric shape using a hierarchical system that assigns different size extensions of the geometric shape to different size extension tiers.

Clause 8. The method in accordance with any preceding clauses, further comprising selecting an applicable size extension tier from among the different size extension tiers responsive to heatmap data derived from a heatmap image.

Clause 9. The method in accordance with any preceding clauses, further comprising selecting an applicable size extension tier from among the different size extension tiers responsive to subscription data.

Clause 10. The method in accordance with any preceding clauses, further comprising, determining a time duration of an extension of a size of the geometric shape using a hierarchical system that assigns different time duration extensions to different time duration tiers.

Clause 11. The method in accordance with any preceding clauses, further comprising selecting an applicable time duration tier from among the different time duration tiers responsive to heatmap data derived from a heatmap image.

Clause 12. The method in accordance with any preceding clauses, further comprising selecting an applicable time duration tier from among the different time duration tiers responsive to subscription data.

Clause 13. The method in accordance with any preceding clauses, further comprising generating different representations of the physical region of interest proximate to the user that respectively correspond to different subscribing businesses.

Clause 14. The method in accordance with any preceding clauses, further comprising generating geometric shapes corresponding to at least two of the different representations to have different sizes.

Clause 15. The method in accordance with any preceding clauses, further comprising generating geometric shapes corresponding to at least two of the different representations to have different durations during which sizes of geometric shapes are extended.

Clause 16. The method in accordance with any preceding clauses, further comprising dynamically creating the different representations responsive to the user moving proximate to the different subscribing businesses.

Clause 17. The method in accordance with any preceding clauses, further comprising providing marketing and traffic information to the businesses using a hierarchical system that assigns different access levels to the marketing and traffic information to different tiers.

Clause 18. The method in accordance with any preceding clauses, wherein the marketing and traffic information comprises foot traffic information corresponding to a respective one or more areas proximate to the businesses.

Clause 19. A system for filtering data transmitted to a user device of a subscribing consumer, comprising: a receiver configured to receive location information and trajectory information of the subscribing consumer; one or more memories, individually or in combination, having instructions and an advertisements database that includes one or more advertisements and location information for each respective business from a subscriber database; one or more processors each coupled to at least one of the one or more memories and configurable/operable to execute the instructions to: subscribe users from among businesses and consumers to a proximity-based mobile advertising service to form a subscriber database; represent based on the location information of a subscribing business, a physical region of interest proximate to the subscribing business by a geometric shape; and filter the advertisements database, to select for display to a subscribing consumer, at least one advertisement corresponding to the subscribing business, responsive to a user trajectory being within at least a portion the geometric shape; and a transmitter configured to transmit the at least one advertisement to the user device of the subscribing consumer.

Clause 20. A method for filtering data transmitted to a user device of a user, comprising: subscribing, by a server having one or more processors, one or more memories, a transmitter and a receiver, users from among businesses and consumers, to a proximity-based event and content access service to form a subscriber database of subscriber information; storing, by the one or more memories, exclusive digital content provided by the businesses in an exclusive digital content database; receiving, by the receiver, location information and trajectory information of the user; representing, by the one or more processors based on the location information and the trajectory information of the user, a physical region of interest proximate to the user by a geometric shape; filtering, by the one or more processors, the exclusive digital content database to identify one or more items of exclusive digital content provided by one or more of the businesses that are within a trajectory of at least a portion of the geometric shape; and transmitting, by the transmitter to the user device, the one or more items of exclusive digital content.

Clause 21. The method in accordance with clause 20, further comprising: accessing the subscriber information in the subscriber database to determine user preferences with respect to types of digital content to be received by the user, wherein filtering the exclusive digital content database comprises filtering the exclusive digital content provided by one or more of the businesses that are within the trajectory of at least the portion of the geometric shape based on the user preferences with respect to types of digital content to be received by the user.

Clause 22. A system for filtering data trans mitted to a user device of a user, comprising: a receiver configured to receive location information and trajectory information of the user; one or more memories, individually or in combination, having instructions and an exclusive digital content database including exclusive digital content provided by businesses; one or more processors each coupled to at least one of the one or more memories and configurable/operable to execute the instructions to: subscribe users from among the businesses and consumers, to a proximity based event and content access service to form a subscriber database of subscriber information; store exclusive digital content provided by the businesses in an exclusive digital content database; represent, based on the location information and the trajectory information of the user, a physical region of interest proximate to the user by a geometric shape; and filter the exclusive digital content database to identify one or more items of exclusive digital content provided by one or more of the businesses that are within a trajectory of at least a portion of the geometric shape; and a transmitter configured to transmit the one or more items of exclusive digital content.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for filtering data transmitted to a user device of a user, comprising:
subscribing, by a server having one or more processors, one or more memories, a transmitter and a receiver, users from among businesses and consumers, to a proximity-based mobile advertising service, to form a subscriber database that includes location information of subscribing businesses;
storing, by the one or more memories, an advertisements database that includes one or more advertisements for each respective subscribing business from the subscriber database;
receiving, by the receiver, location information and trajectory information of the user;
representing, by the one or more processors based on the location information of a subscribing business, a physical region of interest proximate to the subscribing business by a geometric shape;
filtering, by the one or more processors, the advertisements database, to select for display to the user, at least one advertisement corresponding to the subscribing business, responsive to a user trajectory being within at least a portion the geometric shape; and
transmitting, by the transmitter to the user device, the at least one advertisement.

2. The method in accordance with claim 1, further comprising dynamically adjusting a size of the geometric shape based on one or more sizing criteria.

3. The method in accordance with claim 1, further comprising dynamically determining an extended size of the geometric shape based on sizing criteria.

4. The method in accordance with claim 3, further comprising dynamically determining a time duration for the extended size of the geometric shape based on the sizing criteria.

5. The method in accordance with claim 3, further comprising determining the sizing criteria based on heatmap data for a region proximate to the subscribing business.

6. The method in accordance with claim 3, further comprising determining the sizing criteria based on a subscription level in a hierarchical system that assigns extended sizes to the geometric shape.

7. The method in accordance with claim 1, further comprising, determining an extension of a size of the geometric shape using a hierarchical system that assigns different size extensions of the geometric shape to different size extension tiers.

8. The method in accordance with claim 7, further comprising selecting an applicable size extension tier from among the different size extension tiers responsive to heatmap data derived from a heatmap image.

9. The method in accordance with claim 7, further comprising selecting an applicable size extension tier from among the different size extension tiers responsive to subscription data.

10. The method in accordance with claim 1, further comprising, determining a time duration of an extension of a size of the geometric shape using a hierarchical system that assigns different time duration extensions to different time duration tiers.

11. The method in accordance with claim 10, further comprising selecting an applicable time duration tier from among the different time duration tiers responsive to heatmap data derived from a heatmap image.

12. The method in accordance with claim 10, further comprising selecting an applicable time duration tier from among the different time duration tiers responsive to subscription data.

13. The method in accordance with claim 1, further comprising generating different representations of the physical region of interest proximate to the user that respectively correspond to different subscribing businesses.

14. The method in accordance with claim 13, further comprising generating geometric shapes corresponding to at least two of the different representations to have different sizes.

15. The method in accordance with claim 13, further comprising generating geometric shapes corresponding to at least two of the different representations to have different durations during which sizes of geometric shapes are extended.

16. The method in accordance with claim 14, further comprising dynamically creating the different representations responsive to the user moving proximate to the different subscribing businesses.

17. The method in accordance with claim 1, further comprising providing marketing and traffic information to the businesses using a hierarchical system that assigns different access levels to the marketing and traffic information to different tiers.

18. The method in accordance with claim 17, wherein the marketing and traffic information comprises foot traffic information corresponding to a respective one or more areas proximate to the businesses.

19. A system for filtering data transmitted to a user device of a subscribing consumer, comprising:
a receiver configured to receive location information and trajectory information of the subscribing consumer;
one or more memories, individually or in combination, having instructions and an advertisements database that includes one or more advertisements and location information for each respective business from a subscriber database;
one or more processors each coupled to at least one of the one or more memories and configurable/operable to execute the instructions to:
subscribe users from among businesses and consumers to a proximity-based mobile advertising service to form a subscriber database;
represent based on the location information of a subscribing business, a physical region of interest proximate to the subscribing business by a geometric shape; and
filter the advertisements database, to select for display to a subscribing consumer, at least one advertisement corresponding to the subscribing business, responsive to a user trajectory being within at least a portion the geometric shape; and
a transmitter configured to transmit the at least one advertisement to the user device of the subscribing consumer.

20. A method for filtering data transmitted to a user device of a user, comprising:
subscribing, by a server having one or more processors, one or more memories, a transmitter and a receiver, users from among businesses and consumers, to a proximity-based event and content access service to form a subscriber database of subscriber information;
storing, by the one or more memories, exclusive digital content provided by the businesses in an exclusive digital content database;
receiving, by the receiver, location information and trajectory information of the user;
representing, by the one or more processors based on the location information and the trajectory information of the user, a physical region of interest proximate to the user by a geometric shape;
filtering, by the one or more processors, the exclusive digital content database to identify one or more items of exclusive digital content provided by one or more of the businesses that are within a trajectory of at least a portion of the geometric shape; and
transmitting, by the transmitter to the user device, the one or more items of exclusive digital content.

21. The method in accordance with claim 20, further comprising:
accessing the subscriber information in the subscriber database to determine user preferences with respect to types of digital content to be received by the user,
wherein filtering the exclusive digital content database comprises filtering the exclusive digital content provided by one or more of the businesses that are within the trajectory of at least the portion of the geometric shape based on the user preferences with respect to types of digital content to be received by the user.

22. A system for filtering data trans mitted to a user device of a user, comprising:
a receiver configured to receive location information and trajectory information of the user;
one or more memories, individually or in combination, having instructions and an exclusive digital content database including exclusive digital content provided by businesses;
one or more processors each coupled to at least one of the one or more memories and configurable/operable to execute the instructions to:
subscribe users from among the businesses and consumers, to a proximity based event and content access service to form a subscriber database of subscriber information;
store exclusive digital content provided by the businesses in an exclusive digital content database;
represent, based on the location information and the trajectory information of the user, a physical region of interest proximate to the user by a geometric shape; and
filter the exclusive digital content database to identify one or more items of exclusive digital content provided by one or more of the businesses that are within a trajectory of at least a portion of the geometric shape; and
a transmitter configured to transmit the one or more items of exclusive digital content.
